(19) United States
(12) Patent Application Publication
(10) Pub. No.: US 2009/0240588 A1
(43) Pub. Date: Sep. 24, 2009

(54) Method And Apparatus For A Promotional Couponing System

(75) Inventors: Daniel James Turner, Reading (GB); Eric James Meyerhofer, Pasadena, CA (US); John J. Hilbert, Torrance, CA (US)

Correspondence Address: FITZPATRICK CELLA HARPER & SCINTO, 30 ROCKEFELLER PLAZA, NEW YORK, NY, 10112, US

(73) Assignee: FutureLogic, Inc., Glendale, CA (US)

(21) Appl. No.: 12/427,616

(22) Filed: Apr. 21, 2009

Related U.S. Application Data
(63) Continuation-in-part of application No. 12/088,083.
(60) Provisional application No. 60/722,557, filed on Sep. 30, 2005.
(60) Provisional application No. 61/046,534, filed on Apr. 21, 2008.
(60) Provisional application No. 61/103,210, filed on Oct. 6, 2008.
(60) Provisional application No. 61/108,103, filed on Oct. 24, 2008.

(51) Int. Cl. G06Q 30/00

(52) U.S. Cl. 705/14

(57) ABSTRACT

Methods and apparatus for promotional couponing system where coupons, campaigns, and promotions are designed on central server and issued to network of printing devices and redeemed from redemption devices. The logic that processes input contained within each printer and print and redeem device connected to network so each device independently analyzes its own input and requests permission to print coupon from central server. The system uses coupons to maneuver players to play games least in use or to a specific location. Coupons include map and directions to direct the player.

### CROSS-REFERENCE TO RELATED APPLICATION(S)

This application is a continuation-in-part of U.S. application Ser. No. 12/088,083, filed Mar. 25, 2008, which is a national stage application of PCT Application No. PCT/US06/38492, filed Oct. 2, 2006, which claims the benefit of U.S. Provisional. Patent Application No. 60/722,557, filed Sep. 30, 2005, and claims the benefit of U.S. Provisional Patent Application No. 61/046,534, filed Apr. 21, 2008, U.S. Provisional Patent Application No. 61/103,210, filed Oct. 6, 2008, and U.S. Provisional Patent Application No. 61/108,103, filed Oct. 24, 2008 the contents of each of which are hereby incorporated by reference as if stated in full herein.

### BACKGROUND OF THE INVENTION

1. Field of the Invention

This invention relates generally to printers and printer connected hardware used in cashless slot machines and gaming, and more specifically to hardware and software operating within this equipment performing promotional ticket printing, promotional data basing and triggering where a promotional couponing system allows an administrator to design coupons, campaigns, and promotions on a central server and to issue these to a broad area network of printing and redemption devices. The logic that processes various input is contained within each printer and print and redeem device connected to this network so that each device independently analyzes its own input and requests permission to print a coupon from a central server.

2. Background

Gaming machine manufacturers have introduced cashless enabled gaming machines to the market and these have begun to find wide acceptance in the gaming industry. Cashless enabled gaming machines are so named because they can conduct financial exchanges using a mixture of traditional currencies and vouchers. Typically, a cashless enabled gaming machine has a gaming printer to produce vouchers and a bill acceptor that supports automatic reading of vouchers. To coordinate the activities of multiple cashless enabled gaming machines, one or more cashless enabled gaming machines may be electronically coupled to a cashless enabled gaming machine system that controls the cashless operations of a cashless enabled gaming machine.

### SUMMARY OF THE INVENTION

The present invention is a promotional couponing system where coupons, campaigns, and promotions are designed on a central server and issued to a network of printing devices and redeemed from redemption devices. The logic that processes input is contained with each printer and print and redeem device connected to this network so that each device independently analyzes its own input and requests permission to print coupon from a central server. The system uses coupons to maneuver players to play games least in use or to a specific location in the gaming establishment or elsewhere. Coupons include a map and directions to direct the player.

In one aspect of the invention, a gaming establishment can direct one or more players to one or more games that are the least played or among the least played games in the gaming establishment. Using a system in accordance with an exemplary embodiment of the present invention described herein, a gaming establishment can create a promotional coupon to direct or maneuver a player to a certain game in the gaming establishment or elsewhere. The promotional coupon can include a map and/or directions, among others to guide a player. Parameters and triggers can be set such as game identification, game name, number of plays, and number of wins and/or losses, among others. The data is saved on a host system and sent to a printer in one or more cashless enabled gaming machines and or print and redeem devices, and if the criteria set are met, the player receives the promotional coupon. The player can then use the promotional coupon to locate the game to play.

In another aspect of the invention, a promotional couponing system (herein called the “PCS”) connects to one or more games and one or more systems such as a TITO system.

In another aspect of the invention, the PCS uses one or more rules engines to trigger the issuance of coupons to players and/or patrons, the players and/or patrons known or unknown in a system such as the player tracking system (herein called the “PTS”).

In another aspect of the invention, the PCS provides the means where an administrator designs coupons, campaigns, and promotions to be issued to one or more players and/or patrons using one or more printers and/or print and redeem devices.

In another aspect of the invention, the PCS provides the means to offer future incentives to players and/or patrons for a return visit.

In another aspect of the invention, the PCS provides the means for bonusing where the bonusing runs a promotion targeting a specific location.

In another aspect of the invention, the PCS provides the means to steer players and/or patrons around property venues using campaigns and/or promotions.

In another aspect of the invention, access to the PCS includes a connection to other systems such as the Internet.

In another aspect of the invention, the PCS includes one or more database where a database is used for a scavenger hunt module.

In another aspect of the invention, the PCS includes algorithms for a scavenger hunt, the algorithms permitting a scavenger hunt to be conducted on a sub-set of tickets.

In another aspect of the invention, the scavenger hunt module permits a temporary scavenger hunt session tracking where each patron's session is unique and with its own outcome.

In another aspect of the invention, the scavenger hunt module allows tickets to be virtual, with only one physical registration coupon.

In another aspect of the invention, the PCS scavenger hunt module uses components such as a print and redeem device to read coupons collected by the patron during a scavenger hunt session.

### BRIEF DESCRIPTION OF THE DRAWINGS

These and other features, aspects, and advantages of the present invention will become better understood with regard to the following description, accompanying drawings and appendix where:

FIG. 1 is a process flow diagram of the PCS in accordance with an exemplary embodiment of the present invention;

FIG. 2 is an illustration of the attributes of the print regions of a promotional coupon template in accordance with an exemplary embodiment of the present invention;

FIG. 3 is an illustration of a promotional coupon including logical fields in accordance with an exemplary embodiment of the present invention;

FIG. 4 is a flow chart of a load, check, and verify CRC process for a promotional campaign in accordance with an exemplary embodiment of the present invention;

FIG. 5 is an illustration of data stored in the memory of a printer in accordance with an exemplary embodiment of the present invention;

FIG. 6 is a process flow diagram for vouchers and promotional data in a gaming environment in accordance with an exemplary embodiment of the present invention;

FIG. 7 is a block diagram of a printer in accordance with an exemplary embodiment of the present invention;

FIG. 8 is a block diagram of a host system for hosting the PCS in accordance with an exemplary embodiment of the present invention;

FIG. 9 is a block diagram of a routing device in accordance with an exemplary embodiment of the present invention;

FIG. 10 is a block diagram of a print and redeem device in accordance with an exemplary embodiment of the present invention;

FIG. 11 is a diagram illustrating the components and architecture of the PCS in accordance with an exemplary embodiment of the present invention;

FIG. 12 is an illustration of the servers, cluster controllers, games, and components thereof used for the PCS in accordance with an exemplary embodiment of the present invention;

FIG. 13 is a diagram illustrating the components of the PCS directing players to one or a plurality of games in accordance with an exemplary embodiment of the present invention;

FIG. 14 is an illustration of a promotional coupon for player guidance in accordance with an exemplary embodiment of the present invention;

FIG. 15 is an illustration of a functional mode of direct anonymous incentive of the PCS in accordance with an exemplary embodiment of the present invention;

FIG. 16 is an illustration of a functional mode of direct carded player of the PCS in accordance with an exemplary embodiment of the present invention;

FIG. 17 is an illustration of a functional mode of future incentive of the PCS in accordance with an exemplary embodiment of the present invention;

FIG. 18 is an illustration of a functional mode of lure to player club of the PCS in accordance with an exemplary embodiment of the present invention;

FIG. 19 is an illustration of a functional mode of player club enhancement of the PCS in accordance with an exemplary embodiment of the present invention;

FIG. 20 is an illustration of a functional mode of auxiliary bonusing of the PCS in accordance with an exemplary embodiment of the present invention;

FIG. 21 is an illustration of a functional mode of progressive couponing of the PCS in accordance with an exemplary embodiment of the present invention;

FIG. 22 is an illustration of a functional mode of patron steering and circulation of the PCS in accordance with an exemplary embodiment of the present invention;

FIG. 23 is an illustration of a functional mode of scavenger hunt of the PCS in accordance with an exemplary embodiment of the present invention;

FIG. 24 is an illustration of a functional mode of load sharing of the PCS in accordance with an exemplary embodiment of the present invention;

FIG. 25 is an illustration of the components of the PCS in accordance with an exemplary embodiment of the present invention;

FIG. 26 is an illustration of a grouping of various rules engines into their respective classes in accordance with an exemplary embodiment of the present invention;

FIG. 27 is an illustration of how different rules engines may be loaded into printers at various types of locations in accordance with an exemplary embodiment of the present invention;

FIG. 28 is an illustration of a rule engine for slot metrics in accordance with an exemplary embodiment of the present invention;

FIG. 29 is an illustration of a promotion and campaign database architecture in accordance with an exemplary embodiment of the present invention;

FIG. 30 is an illustration of how G2S can be used as a protocol to obtain the various metrics which would be sifted to look for triggers in accordance with an exemplary embodiment of the present invention;

FIG. 31 is an illustration of a typical connection of the PCS within a casino in accordance with an exemplary embodiment of the present invention;

FIG. 32 is an illustration of a connection of the PCS and its printers within a GSA defined casino network topology in accordance with an exemplary embodiment of the present invention;

FIG. 33 is an illustration of the PCS connecting to various administrator clients via the Internet in accordance with an exemplary embodiment of the present invention;

FIG. 34 is another illustration of the PCS as an enabling technology in accordance with an exemplary embodiment of the present invention;

FIG. 35 is a flow chart of security measures in the PCS in accordance with an exemplary embodiment of the present invention;

FIG. 36 is an illustration of a connection of the PCS and one of its printers to a casino multi system environment in accordance with an exemplary embodiment of the present invention;

FIG. 37 is an illustration of the PCS in relation to scavenger hunt in accordance with an exemplary embodiment of the present invention; and

APPENDIX A is a list of definitions of terms as used herein.

Identically labeled elements appearing in different ones of the figures refer to the same elements but may not be referenced in the description for all figures.

### DETAILED DESCRIPTION OF THE INVENTION

Cashless enabled gaming machines have found increasing acceptance and use in the gaming industry with players who enjoy the speed of play and ease of transporting their winnings around a gaming establishment and the gaming establishments who have realized significant labor savings in the form of reduced coin hopper reloads in the games, and an increase in revenue because of the speed of play. Gaming and vending machine manufacturers have increasingly added additional printing features to their gaming and vending machines. One of these features is the ability to create promotional coupons. However, the inventors have observed that there is no method or system in place to create, issue, and manage promotional coupons, promotions, or promotional campaigns which may be transmitted to, stored in, and used by a printer.

Promotional coupon generation and issuance can include a system which edits the layout of a coupon template. While this method may allow a user to design coupons, the inventors have observed that it does not allow the association of coupons to one or more promotions or the association of one or more promotions to a promotional campaign. Another problem with this method is the inability to copy coupon print regions from one coupon template to another template.

Promotional coupon generation and issuance can also include the direct mailing of coupons from a gaming or other business establishment to consumers. The inventors have observed that one problem that plagues this method is that the promotion must be planned well in advance to accommodate the printing and mailing of the promotional coupons to consumers. Another problem is direct mailing and printing is not cost effective. Another problem is that the preprinted promotional coupons cannot be directly inserted into or read by a bill acceptor in a gaming or vending machine. The preprinted promotional coupons must be processed by hand, the process which lends itself to fraud and security issues such as forgery.

Promotional coupon generation and issuance can also include providing consumers the means to download promotions from a networked environment (typically the Internet) for a gaming or other business establishment. In addition to some of the problems cited for the previously described existing methods, the inventors have observed that problems for this existing method also include the lack of the consumer's presence at a gaming or other business establishment which reduces the promotion's overall effectiveness and coupon redemption. In a method related to the generation and issuance of promotional coupons, comps can be issued by a gaming establishment to a consumer. Comps can include free meals, drinks, show tickets, special room rates, room upgrades, match play coupons, and free cash. The inventors have observed that the problem with this method is that the comp is usually processed or issued by a cashier, pit boss, or floor person whereby it must be determined if the consumer should receive a comp.

Therefore, gaming establishments and vendors use multiple promotion methods to induce individuals to patronize the gaming establishment or associated gaming establishments or other types of establishments. However, there is no method or system in place to create, issue, and manage promotional coupons, promotions, and promotional campaigns which may be transmitted to, stored in, and used by a printer for example already installed within a cashless enabled gaming machine system. There exists a need, therefore, to provide a way to create, issue, and manage promotional coupons, promotions, and promotional campaigns. Various systems in accordance with exemplary embodiments of the present invention meet such a need.

The present invention is a promotional coupon system (herein called “PCS”) which is an electronic coupon marketing solution that allows an administrator to design coupons, campaigns, and promotions on a central server and to issue these to a broad area network of printing and redemption devices. The logic that processes various input is contained within each printer and print and redeem device connected to this network so that each device independently analyzes its own input and requests permission to print a coupon from a central server.

Benefits of casino promotional printing and coupons include reaching out to 100 percent of the players, including non-members of a PTS, encouraging players to join club programs, enhancing existing player club programs, cross steering players and/or shoppers, providing visual feedback to players is powerful, and providing means for possible cooperative coupon ventures. This specification identifies data structures, protocols, processing logic, and functions among others of the PCS.

An exemplary use of the PCS is within a casino environment such as in a casino/retail operation located in Las Vegas. This exemplary use is utilized for the descriptions within this specification, but the practical descriptions in no means limit the uses of the PCS and invention.

For example, a gaming establishment can direct one or more players to one or more games that are the least played or among the least played games in the gaming establishment. Using a system in accordance with an exemplary embodiment of the present invention described herein, a gaming establishment can create a promotional coupon to direct or maneuver a player to a certain game in the gaming establishment or elsewhere. The promotional coupon can include a map and/or directions, among others to guide a player. Parameters and triggers can be set such as game identification, game name, number of plays, and number of wins and/or losses, among others. The data is saved on a host system and sent to a printer in one or more cashless enabled gaming machines, and if the criteria set are met, the player receives the promotional coupon. The player can then use the promotional coupon to locate the game to play.

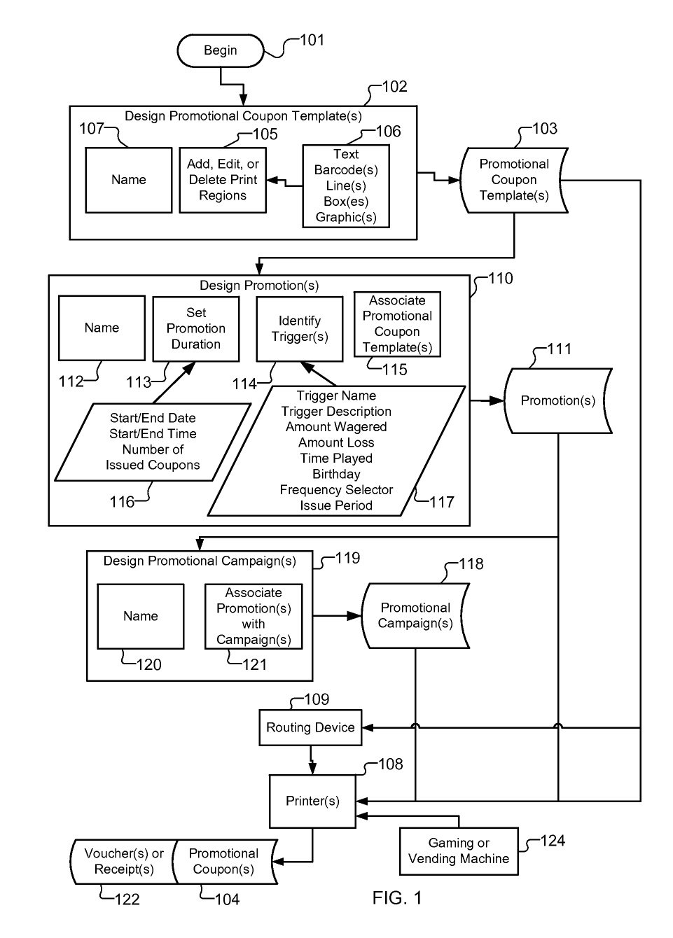

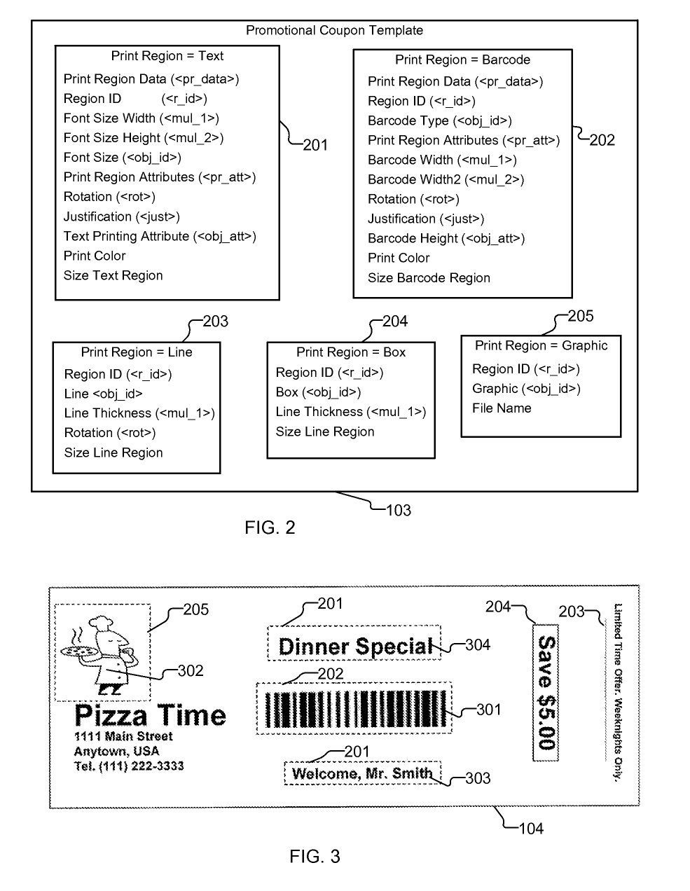

FIG. 1 is a process flow diagram of the PCS in accordance with an exemplary embodiment of the present invention. As illustrated the process begins (101) when a user uses a user input device (not shown) to design (102) a promotional coupon template 103 which is used to create promotional coupons 104. Print regions 106 can be added, edited, or deleted (105) from promotional coupon template 103. The print regions which may be included on promotional coupon template 103 are text or plurality of text, a barcode or plurality of barcodes, a line or plurality of lines, a graphic or plurality of graphics, and a box or plurality of boxes, as shown in element 106 as well as disclosed in FIG. 2. As promotional coupon template 103 is designed, the appearance of promotional coupons 104 displays to the user on a user output device (not shown) such as a screen or other display.

Each promotional coupon template is given a name 107. The data for promotional coupon template 103 is stored on a host system and may be used in a promotion 111 or a plurality of promotions. The data for each promotional coupon template 103 may also be transmitted to, stored in, and used by a printer 108 or plurality of printers to generate promotional coupon 104 or a plurality of promotional coupons.

The data for each promotional coupon template 103 may also be transmitted to and stored in a routing device 109 or a plurality of routing devices, each which is coupled to a printer, such as printer 108. Routing device 109 transmits the stored data to printer 108 to generate promotional coupon 104 or a plurality of promotional coupons.

If promotional coupon template 103 or plurality of promotional coupon templates is used in a promotion 111 or plurality of promotions, the process continues with the design (110) of a promotion 111 or plurality of promotions. Each promotion 111 is given a name 112, the promotion duration is set (113), triggers are identified (114), and promotional coupon templates are associated (115). The promotion duration parameters 116 include start and end date, start and end time, and number of issued coupons, among others. The triggers 117 include amount wagered, amount loss, time played, birthday, frequency selector, and issue period among others. The promotional coupon trigger is given a name and described. The data for each promotion 111 is stored on a host system and may be used in any promotional campaign 118 or plurality of promotional campaigns. The data for each promotion may also be transmitted to printer 108 or plurality of printers to generate promotional coupon 104 or a plurality of promotional coupons.

The data for each promotion may also be transmitted to and stored in routing device 109 or a plurality of routing devices, each which is coupled to a printer, such as printer 108. Routing device 109 transmits the stored data to printer 108 to generate promotional coupon 104 or a plurality of promotional coupons.

If promotion 111 or plurality of promotions is to be used in a promotional campaign 118 or plurality of promotional campaigns, the process continues with the design (119) of a promotional campaign or plurality of promotional campaigns. Each promotional campaign is given a name 120 and a promotion or plurality of promotions is associated (121) with each promotional campaign 118. The data for each promotional campaign 118 is stored on a host system and may be transmitted to printer 108 or a plurality of printers to generate promotional coupon 104 or a plurality of promotional coupons.

The data for each promotional campaign 118 may also be transmitted to and stored in routing device 109 or a plurality of routing devices, each which is coupled to a printer, such as printer 108. Routing device 109 transmits the stored data to printer 108 to generate promotional coupon 104 or a plurality of promotional coupons. In addition, as printer 108 is also coupled to a gaming or vending machine 124, printer 108 may print vouchers 122 along with coupon 104.

In a system in accordance with an exemplary embodiment of the present invention, data for promotional coupon templates 103, promotions 111, and promotional campaigns 118 are stored in routing device 109 coupled to printer 108. In this system, the PCS transmits the data for promotional coupon templates, promotions, and promotional campaigns to routing device. When all the parameters 116 for a promotion or promotional campaign are met, the routing device transmits the stored data to printer 108 to generate promotional coupon(s) 104.

In another system in accordance with an exemplary embodiment of the present invention, a user can create promotional coupons 104, promotions 111, and promotional campaigns 118 in real time, thereby allowing up-to-the-minute or last-minute implementations. Using such a system, the gaming establishment creates the promotional coupon template 103 and the promotion 111. The data for the promotional coupon and promotion is saved on the host system and sent to printer 108 in one or more cashless enabled gaming machines. If the criteria such as parameters 116 and triggers 117 set for the promotion is met, the printer then issues the promotional coupon to a consumer.

In another system in accordance with an exemplary embodiment of the present invention, coupon templates 103 written in a template definition language, promotions 111, and promotional campaigns 118 are designed using a host system and a graphical front-end to a template definition language.

When a gaming or other business establishment desires to define a promotional coupon, the promotional coupon template where the layout and print regions of text, graphics, barcodes, lines, and boxes are defined displays. A gaming or other business establishment defines the layout of promotional coupon templates 103 by placing print regions 106 on the promotional coupon template. For example, the user desires to place a barcode as a print region on promotional coupon templates 103. The user selects the barcode option to define the parameters or attributes for that barcode. The parameters or attributes include, for example, region ID, region data, region size, object ID, object rotation, object width, object justification, object attributes, print attributes, and print color among others. These parameters or attributes are also used to modify a print region. Further detail is disclosed in FIG. 2 as well as throughout this specification.

The user can move any print region 106 to another area on promotional coupon templates 103, place a region in front of other regions, or place a region behind other regions.

Another system in accordance with an exemplary embodiment of the present invention allows multiple promotional coupon templates 103 to be created based on existing promotional coupon templates. In this system, a gaming or other business establishment selects an existing promotional coupon template 103 on which additional promotional coupon templates are based. Each additional promotional coupon template inherits the characteristics of the selected existing promotional coupon template but can be separately modified. Using the promotional coupon template editor which displays, a gaming or other business establishment can create a new promotional coupon template, delete a selected promotional coupon template, and display or hide print regions 106 on a promotional coupon template.

Another system in accordance with an exemplary embodiment of the present invention allows the user to adjust the workspace for structuring the promotional coupon templates 103. Thus, if desired, the user can zoom in on the overall layout and print regions 106 of promotional coupon templates 103 to closely view and modify the overall layout and print regions. This feature also permits users to zoom out to view the overall layout and print regions of promotional coupon templates 103.

In another system in accordance with an exemplary embodiment of the present invention, after the gaming or other business establishment defines the print regions 106 for the promotional coupon template 103, a promotional coupon template is stored in a document. The document contains multiple lines. Each line contains a command and the associated parameters required to use that promotional coupon template. The document is stored on a host system and may be incorporated into a new or existing promotion 111. The data may also be transmitted to, stored in and used by printer 108 either alone or with other promotional coupon templates 103 to generate promotional coupons 104. The data may also be transmitted to and stored in a routing device 109 coupled to printer 108, with routing device 109 transmitting the stored data to printer 108 to generate promotional coupons 104.

Another system in accordance with an exemplary embodiment of the present invention allows the overall layout and print regions 106 of promotional coupon templates 103 to be edited or deleted 105. The parameters or attributes for a print region which can be edited include region ID, region data, region size, object ID, object rotation, object width, object justification, object attributes, print attributes, and print color among others. Further detail is disclosed in FIG. 2 as well as throughout this specification.

In addition, one system in accordance with an exemplary embodiment of the present invention allows the export of promotional coupon templates 103 and data for promotional coupons 104, promotions 111, and promotional campaigns 118 for incorporation and use by external software applications such as a casino management system or player tracking system (herein called “PTS”.)

Furthermore, another system in accordance with an exemplary embodiment of the present invention provides various methods of establishing communications with printer 108 for data transmission. In one aspect of such a system, when a gaming or other business establishment desires to set up the communication port to which data is transmitted to printer 108, the communication port settings are displayed. A gaming or other business establishment selects the communication port and the communication protocol baud rate, identifies the polling option and command, and initializes the communication port. In addition, a gaming or other business establishment can locate additional communication ports to which to establish communications with printer 108 or routing device 109.

In another aspect of a system in accordance with an exemplary embodiment of the present invention, when a gaming or other business establishment desires to set up the respective communication ports to which gaming or vending vouchers 122 and promotional coupon 104 data is transmitted to printer 108, the communication ports settings are displayed. A gaming or other business establishment selects a gaming or vending voucher file, selects the communication port and the communication protocol baud rate, and initializes the communication port for the gaming or vending voucher. A gaming or other business establishment repeats this process for a promotional coupon.

A gaming or other business establishment can also set the delay between print option which sets the delay print time between printing a gaming or vending voucher 122 and printing promotional coupons 104. A gaming or other business establishment can also disconnect the communication port for the gaming or vending voucher, the promotional coupon, or both.

When a gaming or other business establishment desires to view the parameters of a print job prior to sending a data to a printer, print job controls are displayed. A gaming or other business establishment can select options such as manually sending the print job, sending all print jobs without delay, sending all print jobs with delay, canceling a print job, and clearing the output log that is created when a print job is sent to printer 108.

A gaming or other business establishment can also view the status of printer 108. When desiring to do so, the printer status displays. A gaming or other business establishment can view any communication errors, such as Universal Asynchronous Receiver Transmitter (UART) errors, view the printer library, and reset printer 108 if necessary.

In another system in accordance with an exemplary embodiment of the present invention, data for promotional campaigns 118 which may be transmitted to printer 108 from a host system, stored in, and used by printer 108 to generate a promotional coupon or a plurality of promotional coupons 104, may be combined with data for promotional coupons. In this system, when a gaming or other business establishment desires to create or edit promotional campaigns 118, the promotions and promotional campaigns are defined displays. After a gaming or other business establishment creates or edits promotional campaigns 118, the system inserts a header in a promotional campaign 118 data file which identifies a promotional campaign. The system also calculates a signature, such as a CRC, based on the contents of the promotional campaign data and sends the signature to printer 108.

In another aspect of a system in accordance with an exemplary embodiment of the present invention, a boundary check on the combined promotional coupon templates 103, print regions 106, graphics and other data which may be included with the promotional campaign 118 data may be performed to ensure conformance with the resources and load requirements of printer 108. In this system, after a gaming or other business establishment transmits data to printer 108, the PCS performs the boundary check by determining the number of promotional coupon templates 103, print regions 106, graphics and other data which may be included with promotional campaign 118 data. The PCS then verifies the signature. After successful verification of the signature, the PCS loads the data for each promotional coupon template 103 and sends the signature to printer 108.

In another aspect of a system in accordance with an exemplary embodiment of the present invention, data for promotional coupon templates 103, promotions 111, and promotional campaigns 118 are stored in the memory of printer 108. In this system, the PCS transmits the data for promotional coupon templates, promotions, and promotional campaigns to printer 108. When all parameters 116 of promotions 111 or promotional campaigns 118 are met, the printer uses the data stored in memory to generate promotional coupons 104.

FIG. 2 is an illustration of the attributes of the print regions of promotional coupon template in accordance with an exemplary embodiment of the present invention.

As illustrated, a promotional coupon template 103 may include text print regions 201, barcode print regions 202, line print regions 203, box print regions 204, and graphic print regions 205.

The attributes for text print region 201 are defined in Table I as follows:

TABLE I

| Attribute | Description |
|---|---|
| Print Region Data | Permanently stored data. Can modify if |
| (<pr_data>) | <pr_att> = dynamic, incrementing, |
| | or decrementing. |
| Region ID (<r_id>) | Print Region identifier. Unique |
| | alphanumeric character. |
| Font Size Width (<mul_1>) | The width of the size of the font. |
| Font Size Height (<mul_2>) | The height of the size of the font. |
| Font Size (<obj_id>) | An object identifier which describes |
| | the size of the font. |
| Print Region Attributes | Special handling instructions for the |
| (<pr_att>) | print region. Options for text include: |
| | Dynamic, Stored, Incrementing, or |
| | Decrementing. |
| Rotation (<rot>) | Rotation of strings or data with the print |
| | region. Options include: 0, 90, 180, or |
| | 270 Degrees. |
| Justification (<just>) | Justification of data within the print |
| | region. Options include: Left, Right, |
| | or Center. |
| Text Printing Attribute | Special handling instructions for the |
| (<obj_att>) | print object. Options for text include: |
| | Normal or Inverse. |
| Print Color | Color of the print region. |
| Size Text Region | Sizing for the print region. Shrink/ |
| | Enlarge width and height. |

The attributes for barcode print region 202 are defined in Table II as follows:

TABLE II

| Attribute | Description |
|---|---|
| Print Region Data | Permanently stored data. Can modify if |
| (<pr_data>) | <pr_att> = dynamic, increment, or |
| | decrement. |
| Region ID (<r_id>) | Print Region identifier. Unique |
| | alphanumeric character. |
| Barcode Type (<obj_id>) | An object identifier which describes |
| | the type of barcode used. |
| Print Region Attributes | Special handling instructions for the |
| (<pr_att>) | print region. Options for barcodes |
| | include: Dynamic, Stored, Increment, |
| | or Decrement. |
| Barcode Width (<mul_1>) | The first width of the barcode. |
| Barcode Width2 (<mul_2>) | The second width of the barcode. |
| Rotation (<rot>) | Rotation of strings or data with print |
| | region. Options include: 0, 90, 180, |
| | or 270 Degrees. |
| Justification (<just>) | Justification of data within print |
| | region. Options include: Left, Right, |
| | or Center. |
| Barcode Height (<obj_att>) | The height of the barcode. |
| Print Color | Color of the print region. |
| Size Barcode Region | Sizing for the print region. Shrink/ |
| | Enlarge width and height. |

The attributes for line print region 203 are defined in Table III as follows:

TABLE III

| Attribute | Description |
|---|---|
| Region ID (<r_id>) | Print Region identifier. Unique Alphanumeric |
| | Character. |
| Line (<obj_id>) | An object identifier which describes a line. |
| Line Thickness | The thickness of the line. |
| (<mul_1>) | |
| Rotation (<rot>) | Rotation of strings or data with print region. |
| | Options include: 0, 90, 180, or 270 Degrees. |
| Size Line Region | Sizing for the print region. Shrink/Enlarge |
| | width and height. |

The attributes for box print region 204 are defined in Table IV as follows:

TABLE IV

| Attribute | Description |
|---|---|
| Region ID (<r_id>) | Print Region identifier. Unique Alphanumeric |
| | Character. |
| Box (<obj_id>) | An object identifier which describes a box. |
| Line Thickness | The thickness of the line. |
| (<mul_1>) | |
| Size Box Region | Sizing for the print region. Shrink/Enlarge |
| | width and height. |

TABLE V

| Attribute | Description |
|---|---|
| Region ID (<r_id>) | Print Region identifier. Unique Alphanumeric |
| | Character. |
| Graphic (<obj_id>) | An object identifier which describes a graphic. |
| File Name | Name of the graphic file. |

FIG. 3 is an illustration of an exemplary promotional coupon including logical fields in accordance with an exemplary embodiment of the present invention. In this example, promotional coupon 104 may include five types of print regions: text 201, barcode 202, graphic 205, line 203, and box 204 as described in FIG. 2. The print regions of a promotional coupon template used to create this example are defined in the PCS and may be stored in a printer, such as printer 108 of FIG. 1. The template may include a plurality of print regions in combination, resulting in a paste-up style printed coupon.

The actual value of data for each print region may or may not be included in the promotional coupon template. For example, a promotional coupon template may include a barcode field 202 for printing a barcode 301. However, the actual value of the barcode is transmitted to printer 108 of FIG. 1 at the time promotional coupon 104 is generated using promotional coupon template 103 of FIG. 1. In this way, promotional coupon 104 may have print regions that include static data, such as a graphic 302 in graphic print region 205, or dynamic data such as the name 303 of a particular patron in a text print region 201. In this way, customized promotional coupons may be printed by printer without transferring large amounts of data through a communications network coupling the printer to a master promotional controller.

In addition, data that is used to track usage of promotional coupons may be included in promotional coupon 104. For example, a barcode field 202 or a text field 201 may be used to print a barcode value 301 or text string 304 uniquely identifying promotional coupon 104. In this way, printer 108 of FIG. 1 creates an image of a barcode or barcodes, characters or marks that may be read by a gaming or vending machine bill acceptor on the same or another gaming or vending machine, allowing automatic acceptance of promotional coupons.

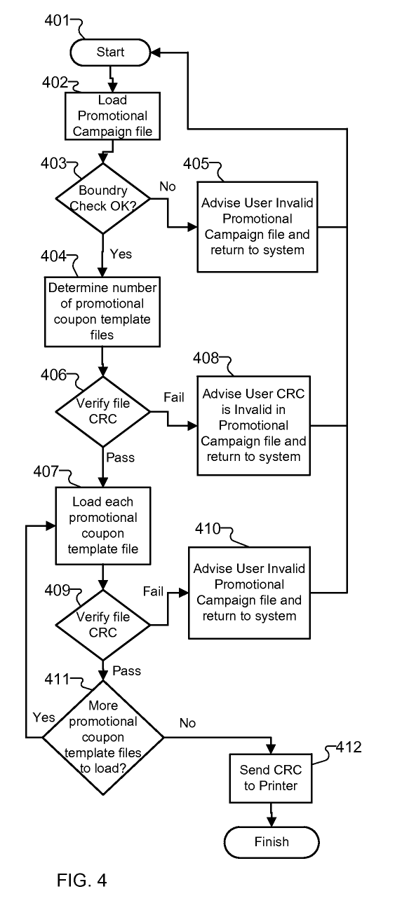

FIG. 4 is a flow chart of the load, check, and verify CRC process for a promotional campaign in accordance with an exemplary embodiment of the present invention.

As illustrated, the process begins (401) with loading (402) promotional campaign data. A boundary check is performed (403). If the promotional campaign data passes the boundary check, the process continues with determining (404) the number of promotional coupon template files. If the promotional campaign data does not pass the boundary check, the system advises (405) the user and returns to the PCS.

After determining the number of promotional coupon template files, a verify file CRC is performed (406) on the promotional campaign data. If the promotional campaign data passes the CRC verification, the process continues with the loading (407) of each promotional coupon template. If the promotional campaign data does not pass the CRC verification, the system advises (408) the user and returns to the PCS.

After loading each promotional coupon template, a verify file CRC is performed (409) on each promotional coupon template in the promotional campaign data. If the promotional campaign data does not pass the CRC verification, the system advises (410) the user and returns to the PCS. If the promotional campaign data passes the CRC verification, the process determines (411) whether there are additional promotional coupon templates to load. If there are additional promotional coupon templates to load, the process returns to 407. If there are no additional promotional coupons to load, the process advances to 412.

At 412, after loading all promotional coupon templates is complete, the process completes with the CRC being sent (412) to the printer.

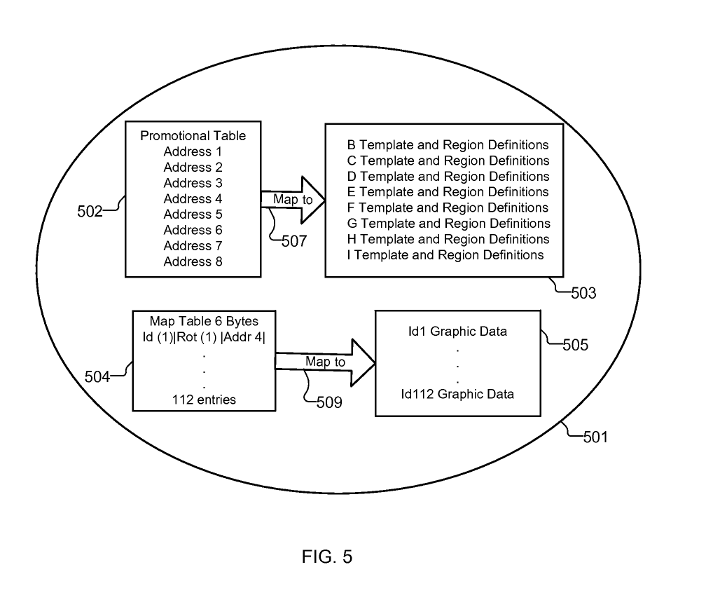

FIG. 5 is an illustration of data stored in the memory of printer in accordance with an exemplary embodiment of the present invention.

As illustrated, a printer memory 501 comprises a promotional table 502, template and region definitions 503, and graphics. The promotional table comprises one or a plurality of addresses. Each address is mapped 507 to a template and region definition. A map table 504 comprises 6 bytes of graphic data as follows: 1 byte for the object identification (ID), 1 byte for the object rotation (Rot); and 4 bytes for the object address (Addr). In this example, the map table may contain a total of 112 entries. Each entry is mapped 509 to graphic data 505 in memory.

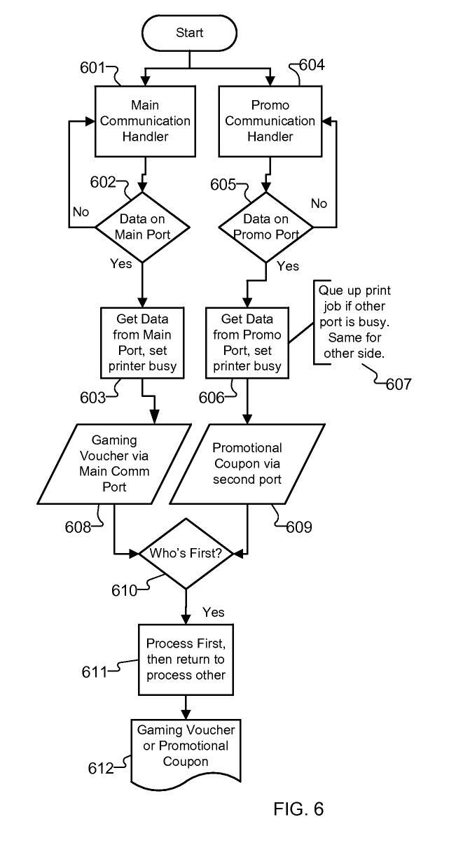

FIG. 6 is a process flow diagram for gaming and vending vouchers and promotional data in a gaming environment in accordance with an exemplary embodiment of the present invention.

As illustrated, the process for vouchers begins with a Main Communication Handler 601. A determination is made (602) whether data exists on the main port. If data, such as a voucher 608, exists on the main port, the system gets (603) the data from the main port and sets the printer to busy. If data does not exist on the main port, the process returns to Main Communication Handler 601.

The process for promotional coupons begins with a Promo Communication Handler 604. A determination is made (605) whether data exists on the promo port. If data, such as a promotional coupon 104 of FIG. 1, exists on the promo port, the system gets (606) the data 609 from the promo port and sets the printer to busy. If data does not exist on the promo port, the process returns to Promo Communication Handler 604.

If the printer is busy using any port, the data from the other port is queued (607).

The process continues with the system identifying (610) which data was received first. Because the process begins with Main Communication Handler 601 determining whether voucher data exists on the main port, if voucher data exists on the main port the voucher data will be identified at 610 as being received first. After identifying the data received first, the system processes (611) the first data to generate a voucher or promotional coupon, then returns to process the second data to generate (612) a voucher or promotional coupon.

In one embodiment, identifying which data was received first is based on a priority. For example, priority can be given to voucher data in the event that voucher data exists on the main port and promotional coupon data exists on the promo port. In another embodiment, priority can be given to voucher data such that even when promotional coupon data is received first, the system waits to receive and print corresponding voucher data prior to printing the promotional coupon data.

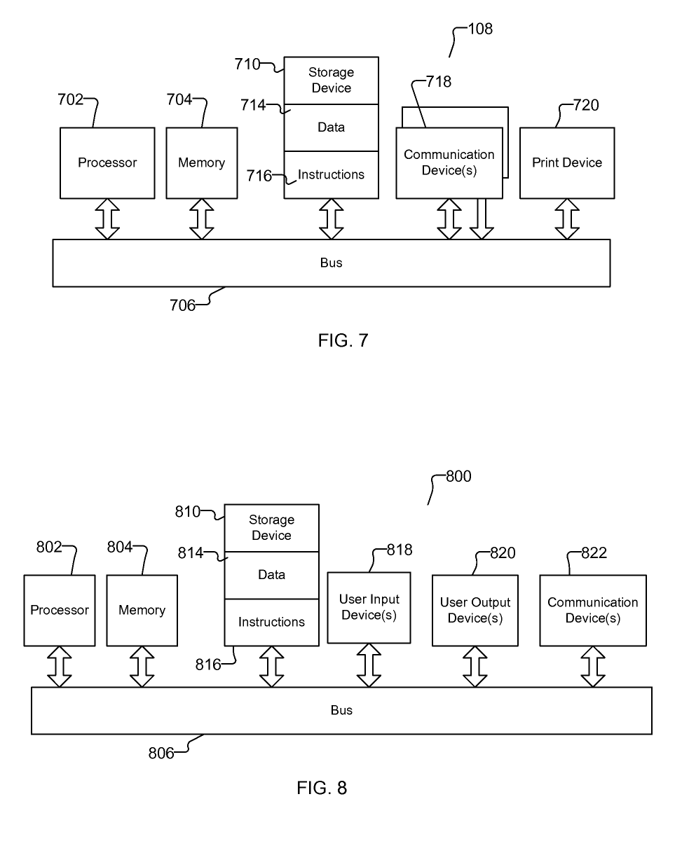

FIG. 7 is a block diagram of an external device such as a printer in accordance with an exemplary embodiment of the present invention.

A printer 108 includes a processor 702, operatively coupled via a bus 706 to a memory 704. The processor is further operatively coupled via the bus to a storage device 710. Program instructions 716 and data 714 implementing described herein voucher and coupon printing processes are stored in the storage device until the processor retrieves the program instructions and stores them in the memory. The processor then executes the program instructions stored in the memory and uses the data to implement the features of the printer as described herein.

The processor is further coupled via the bus to one or more communication devices or ports 718. The printer uses the communication devices to transmit and receive control signals from the PCS, gaming system or gaming machine as described herein.

The processor is further coupled via the system bus to a print device 720. The printer uses the print device to generate vouchers coupons as described herein.

Additionally, external devices can include those described herein such as a slot machine or gaming table, among others.

In one embodiment, the printer includes universal communication including USB 2.0 FS (GSA/GDS, SPC/IGT, SBG). In another embodiment, the printer is a reloadable peripheral; for example, a storage device can be replaced with another storage device.

FIG. 8 is a block diagram of a host system for hosting the PCS in accordance with an exemplary embodiment of the present invention.

A host system 800 contains the programming instructions, memory, security interface means, among others necessary for signaling and data transfer for data verification and other purposes. Any exemplary host system is the PCS used to create, manage and track the issuance and redemption of promotional coupons.

A host 800 includes a processor 802, operatively coupled via a bus 806 to a memory 804. The processor is further operatively coupled via the bus to a storage device 810. Program instructions 816 and data 814 for implementing promotional program generation processes are stored in the storage device until the processor retrieves the program instructions and stores them in the memory. The processor then executes the program instructions stored in the memory and uses the data to implement the features of the PCS processes.

The processor is further coupled via the bus to one or more communications devices or ports 822. The host uses the communications devices to transmit and receive control signals and/or data to and from external devices as described herein.

The processor is further coupled via the bus to one or more user input devices 818 and one or more user output devices 820 for communicating with a user as described herein in order to create a promotional coupon, among others.

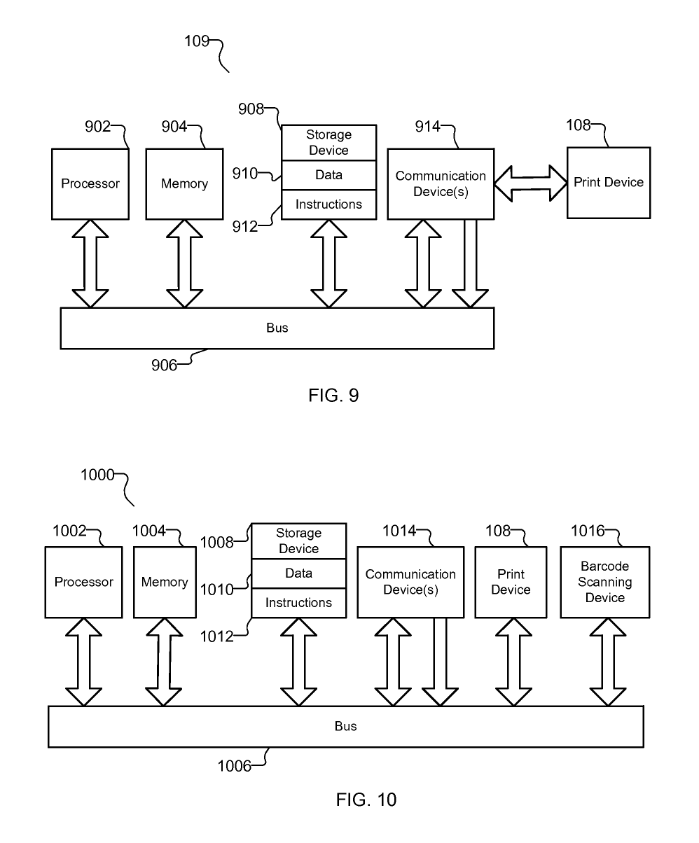

FIG. 9 is a block diagram of a routing device in accordance with an exemplary embodiment of the present invention. Any component may be optional.

A routing device 109 contains the programming instructions, memory, security and interface means, among others necessary for signaling and data transfer of one or a plurality files for data verification and other purposes.

A routing device 109 includes a processor 902, operatively coupled via a bus 906 to a memory 904. The processor 902 is further operatively coupled via the bus 906 to a storage device 908. Program instructions 912 and data 910 implementing described herein voucher and coupon printing processes are stored in the storage device 908 until the processor 902 retrieves the program instructions 912 and stores them in the memory 904. The processor 902 then executes the program instructions 912 stored in the memory 904 and uses the data 910 to implement the features of the processes as described herein.

The processor 902 is further coupled via the bus 906 to one or more communication devices or ports 914. The routing device 109 uses the communication devices to transmit and receive control signals from a host system 800 of FIG. 8 such as the PCS, gaming system or gaming machine as described herein.

The processor 902 is further coupled via the system bus 906 to a print device such as a printer 108. The routing device 109 uses the print device 108 to generate vouchers and/or coupons as described herein.

Additionally, external devices include a slot machine or gaming table, among others.

FIG. 10 is a block diagram of a print and redeem device in accordance with an exemplary embodiment of the present invention.

A print and redeem device 1000 contains the programming instructions, memory, security interface means, among others necessary for signaling and data transfer of one or more files for data verification and other purposes.

A print and redeem device 1000 includes a processor 1002, operatively coupled via a bus 1006 to a memory 1004. The processor 1002 is further operatively coupled via the bus 1006 to a storage device 1008. Program instructions 1012 and data 1010 implementing described processes are stored in the storage device 1008 until the processor 1002 retrieves the program instructions 1012 and stores them in the memory 1004. The processor 1002 then executes the program instructions 1012 stored in the memory 1004 and uses the data 1010 to implement the features of the processes.

The processor 1002 is further coupled via the bus 1006 to one or more communication devices or ports 1014. The print and redeem device 1000 uses the communication devices to securely transmit and receive control signals and/or data to and from any external device such as a host system 800 of FIG. 8, gaming system, gaming machine, handheld device and/or routing device 109 of FIG. 1 as previously described.

The processor 1002 is further coupled via the system bus 1006 to a print device such as a printer 108. The print and redeem device 1000 uses the print device 108 to generate vouchers and/or coupons and to securely generate files as described herein.

The processor 1002 is further coupled via the system bus 1006 to a barcode scanning device 1016. The print and redeem device 1000 uses the barcode scanning device 1016 to scan and redeem coupons and/or vouchers.

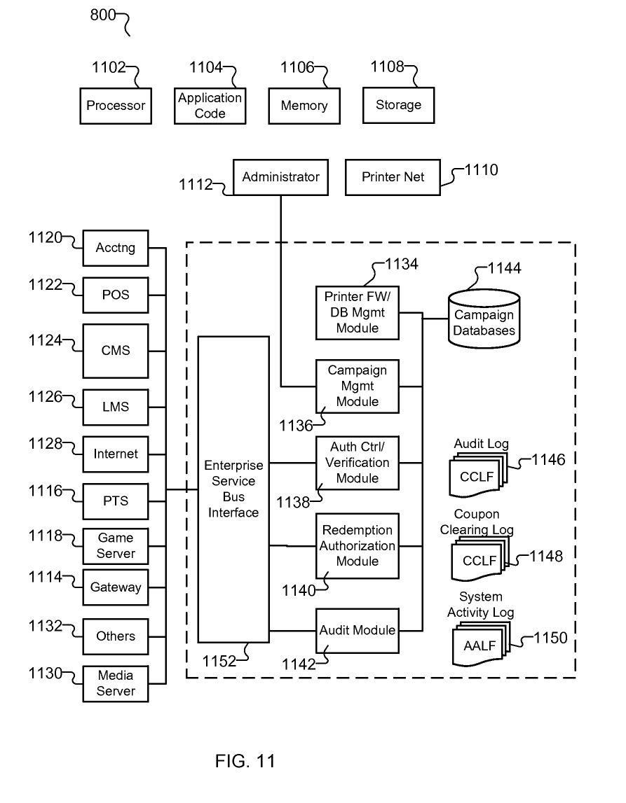

FIG. 11 is a diagram illustrating the components and architecture of the PCS in accordance with an exemplary embodiment of the present invention. A component or plurality of components could be optional.

As shown in FIG. 11, the PCS 800 comprises a processor 1102, memory 1106, application code 1104 containing code for implementing the processes described herein, storage 1108, and a plurality of interfaces to external devices and systems including an interface to a plurality of printers 1110. An exemplary device for the PCS would be a traditional network server. In FIG. 11, the processor 1102, executing the application code 1104, performs the following tasks, among others:
(a) create and maintain a database for storing promotional coupon template, promotion, promotional campaign, triggers, and redemption data, then recalling any of that data at a later time to create a promotional coupon or plurality of such through one of its connected printers, either directly or through a coupled component such as a gateway 1114.
(b) process data related to the creation of promotional coupon templates, promotions, and promotional campaigns, the data including triggers.
(c) process data related to the issuance of promotional coupons, the data including triggers.
(d) process data related to the redemption of promotional coupons.
(e) record and log its activities for statistical and monitoring purposes.
(f) transfer statistical data and activity logs and records to the PCS administrator.
(g) accept programming through its interface to a PCS administrator 1112 as to the algorithms, metrics, and triggers utilized for the creation of a promotional coupon template or plurality of such.
(h) set communication options for both vouchers and promotional coupons to print using the same printer, including initializing each port and polling each printer.
(i) calculate the CRC based on promotional coupon or promotion data; thereafter, based on successful verification of the CRC, loading the promotional coupon or promotion data and sending the CRC to a printer or plurality of printers, either directly or through a coupled component such as a gateway 1114.
(j) request data exchange through the PCS's interface to the PTS 1116 to determine if a promotional coupon or plurality of such is triggered as a result of a player being a member of a frequent player or membership club of a gaming establishment.

(k) request data exchange through the PCS's interface to the PTS 1116 to query player tracking data for the customization of a promotional coupon or plurality of such.
(l) request data exchange through the PCS's interface to the PTS 1116 to determine the validity of the redemption of a promotional coupon or plurality of such, thereby enabling player tracking data is validated against data originally used for a promotional coupon, a promotion, a promotional campaign, a plurality of any, or a combination of any.

(m) request data exchange through the PC S's interface to the POS 1122 for the issuance of a promotional coupon or plurality of such, whereby a trigger or plurality of triggers using data from the POS is used.

(n) request data exchange though the PCS's interface to the POS 1122 to monitor and track the redemption of a promotional coupon or plurality of such, whereby point-of-sale data may be verified against data originally used to create a promotional coupon template, promotion, promotional campaign, a plurality of any, or a combination of any.

(o) request data exchange through the PCS's interface to the Slot Accounting Server 1120 for the issuance of a promotional coupon or plurality of such, whereby a trigger or plurality of triggers using data from the Slot Accounting Server is used.

(p) request data exchange through the PCS's interface to the Slot Accounting Server 1120 to monitor and track the redemption of a promotional coupon or plurality of such, whereby data such as issuing machine may be verified against data originally used to create a promotional coupon template, promotion, promotional campaign, a plurality or a combination of any.

(q) request data exchange through the PCS's interface to a Gateway Server 1114 or plurality of such for the issuance of a promotional coupon or plurality of such, whereby data and one or a plurality of triggers is transmitted to each Gateway Server to permit the issuance of promotional coupons from each printer coupled to selected slot machines or game.

(r) request data exchange through the PCS's interface to a Gateway Server 1114 or plurality of such to monitor and track the redemption of a promotional coupon or plurality of such, whereby data from the Gateway Server or its coupled devices as described herein may be verified against data originally used to create a promotional coupon template, promotion, promotional campaign, a plurality of any, or a combination of any.

(s) request data exchange through the PCS's interface to Other(s) 1132, which may be any other system, network, or device such as a routing device for the issuance of a promotional coupon or plurality of such, whereby data and one or a plurality of triggers is transmitted to and stored in such.

(t) request the PCS's interface to the network of printers 1110 in the system to create a promotional coupon or plurality of such.

(u) monitor the connection through the PCS's interface to the Slot Accounting Server 1120 or one or a plurality of slot machines to receive information from the slot machine and/or to monitor slot machine play metrics directly from a slot machine whereby a trigger or a plurality of triggers using data from the slot machine is used.

The interfaces comprising the protocols, messaging logic, hardware, and buffering necessary to exchange data with the PCS's processor 1102 and application, and among others:

(a) PTS 1116

(b) POS 1122

(c) Slot Accounting Server 1120

(d) Game Server 1118

(e) Gateway Server(s) 1114

(f) Printer(s) 1110

(g) CMS 1124

(h) LMS 1126

(i) Internet 1128

(j) Media Server 1130

(k) Other(s) 1132

(l) Administrator Link 1112

Additionally, the PCS 800 interfaces with one or a plurality of games either directly or through a host system such as a Game Server 1118. In this embodiment, the functionality is the same or equivalent to the Slot Accounting Server 1120 or Gateway Server 1114 where the PCS, its processor 1102, executing the application code 1104, performs the following tasks, among others:
(a) monitor the connection through the PCS's interface to a Game Server 1118 or one or plurality of games to receive information from a game and/or to monitor game play metrics directly from a game whereby a trigger or a plurality of triggers using data from a game is used.
(b) request data exchange through the PC S's interface to a Game Server 1118 or one or plurality of games for the issuance of one or more promotional coupons, whereby a trigger or triggers using data from a game is used.
(c) request data exchange through the PC S's interface to a Game Server 1118 or one or plurality of games to monitor and track the redemption of one or more promotional coupons, whereby data such as issuing game may be verified against data originally used to create a promotional coupon template, promotion, promotional campaign, a plurality of any, or combination of any.
(d) request data exchange through the PC S's interface to a Game Server 1118 or one or plurality of games for the issuance of one or more promotional coupons, whereby data and one or a plurality of triggers is transmitted to each game to permit the issuance of promotional coupons from each printer coupled to selected games.
(e) request data exchange through the PC S's interface to a Game Server 1118 or one or plurality of games to monitor and track the redemption of one or more promotional coupons, whereby data from a game and/or its coupled devices may be verified against data originally used to create a promotional coupon template, promotion, promotional campaign, a plurality of any, or a combination of any.

A number of the interfaces for the PCS 800 may exist on the same physical hardware connection, the attached devices being individual or group-addressable nodes on that connection.

In another embodiment, the PCS 800 is on its own LAN and not connected to one or a plurality of systems in use at a gaming establishment or other business establishment or shares bandwidth with one or a plurality of systems talking a different protocol, for example, it cannot control a game.

Some of the main software modules which make up the architecture of the PCS 800, which is essentially the master of the system are listed in the following table:

TABLE VI

| Server Module | Function |
|---|---|
| Accounting System 1120, POS | Some of the interface drivers which interface the PCS to |
| 1122, CMS 1124, LMS 1126, | other systems at the property. |
| Internet 1128, PTS 1116, Media | |
| Server 1130, Game Server 1118, | |
| Gateway 1114, Others 1132 | |
| Printer Net 1110 | The interface to all the printers that are connected to the |
| | PCS, directly on a property LAN, or through the Internet. |
| Administrator 1112 | The interface to export an administration client to be used |
| | by the PCS administrator for promotion and campaign |
| | design. This is the dashboard control for the PCS. |
| Printer FW/DB Management | Ensures that all printers are downloaded with the proper |
| Module 1134 | promotional databases contained within the PCS. |
| Campaign Management Module | The software which controls administration of the |
| 1136 | campaigns programmed in the PCS. |
| Auth Ctrl/Verification Module | The security software module which verifies that various |
| 1138 | administrators are authorized to utilize and control the PCS. |
| Redemption Authorization | The software which verifies that a scanned validation |
| Module 1140 | sequence on a coupon is valid and gives permission for the |
| | redemption. |
| Audit Module 1142 | The software module which allows system monitor files |
| | (log files) to be pulled from the server for analysis. |

The enterprise service bus interface 1152 provides a connection to other enterprise systems such as POS 1122, CMS 1124, and Internet 1128. The enterprise service bus interface also provides a connection to modules of the PCS such as the audit module 1142 as previously disclosed.

The campaign databases 1144 store information related to each campaign. Each campaign is then loaded to one or more target groups to issue a promotional coupon to a player and/or patron.

The log files of the PCS include an audit log 1146, a coupon clearing log 1148, and a system activity log 1150, among others. The audit log includes information that creates an audit trail of activity of the PCS which can be used for data analysis.

The coupon clearing log 1148 includes information related to promotional coupons such as when the coupon was redeemed and where, among others. The coupon clearing log can be used for data analysis.

The system activity log 1150 includes information related to the PCS and/or components such as connectivity to other systems, errors, and data transfers, among others.

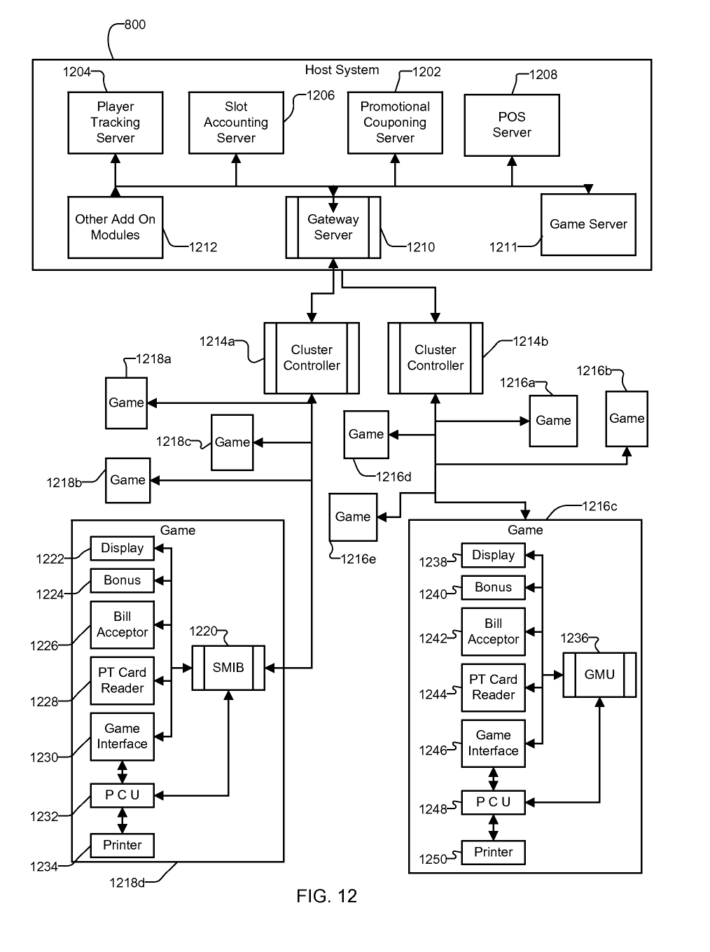

FIG. 12 is an illustration of the servers, cluster controllers, games, and components thereof used for the PCS in a gaming environment in accordance with an exemplary embodiment of the present invention. A component or plurality of components shown in FIG. 12 could be optional.

As illustrated, a host system 800 includes a promotional couponing server 1202, a player tracking server 1204, a slot accounting server 1206, a POS server 1208, a gateway server 1210, a Game Server 1211, and other add on modules 1212, each coupled to each other.

The promotional couponing server 1202 processes data related to promotional couponing such as that described throughout this specification. For example, to create a promotional coupon using a birthday as a trigger and an issuing location, the promotional couponing server may query data such as a player's date of birth from the player tracking server 1204 and machine information from the slot accounting server 1206. To continue with this example, before the promotional coupon can be redeemed at a point-of-sale location, the POS server 1208 may query the PTS 1204 for a player's date of birth.

The POS server 1208 also may query the slot accounting server 1206 to validate machine information such as issuing location. The POS server also may query the promotional couponing server 1202 to validate data for the promotional coupon such as the unique identifier for the promotional coupon.

The player tracking server 1204 processes data related to player tracking. For example, the promotional couponing server 1202 may query data such as a player's name from the player tracking server 1204 to customize a promotional coupon with the name of an individual.

The slot accounting server 1206 processes data related to slot machines. For example, the promotional couponing server 1202 may query data such as the machine identification from the slot accounting server 1206 to unique identify the originating machine that issued a promotional coupon.

The POS server 1208 processes data related to promotional coupon redemption and point-of-sale purchases. For example, in order to validate a promotional coupon for redemption, the POS server may query data such as the unique identifier for the promotional coupon from the promotional couponing server 1202.

The Game Server 1211 processes data related to games such as gaming tables. For example, the promotional couponing server 1202 may monitor and query data such as game play metrics from the Game Server to issue a promotional coupon.

Other add-on modules 1212 process data and support other systems such as a lodging management system, among others. For example, to redeem a promotional coupon for a discount on lodging, a lodging management system may query the promotional couponing server 1202 to validate the promotional coupon.

The gateway server 1210 is coupled to one or more cluster controllers, such as cluster controllers 1214a and 1214b. Each cluster controller further coupled one or more games. For example, cluster controller 1214b is coupled to games 1216a to 1216e and cluster controller 1214a is coupled to games 1218a to 1218d. Each cluster controller is used to control the operation of the associated games. For example, one cluster controller may be used for games located at the north end of a casino floor while another cluster controller may be used for games located at the south end of the casino floor.

Each game such as a slot machine 1218d may comprise a Slot Machine Interface Board (SMIB) 1220, the SMIB coupled to various components that may include a display 1222, bonusing 1224, bill acceptor 1226, Player Tracking (PT) card reader 1228, game interface 1230, and a Printer Controller Unit (PCU 1232) for controlling a printer 1234.

Each game such as a gaming table 1216c may comprise a Game Machine Unit Board (GMU) 1236, the GMU coupled to various components that may include a display 1238, bonusing 1240, bill acceptor 1242, Player Tracking (PT) card reader 1244, game interface 1246, and a Printer Controller Unit (PCU) 1248 for controlling a printer 1250.

The game interface of either game such as a slot machine or gaming table also may be coupled to a printer controller unit, the printer controller unit further coupled to a printer.

The gateway server 1210 is used to process data and convert protocols from all other servers to a cluster controller or a plurality of such. For example, data for the issuance of a promotional coupon or plurality of such is sent from a promotional couponing server 1202 and any of the other servers in a host system 800 through a gateway server 1210 to each cluster controller. The data is then forwarded to the associated games or to selected games. The data resides in the printer controller unit until a trigger or a plurality of triggers is met. Thereafter, the data is used by the printer to generate a promotional coupon or plurality of such.

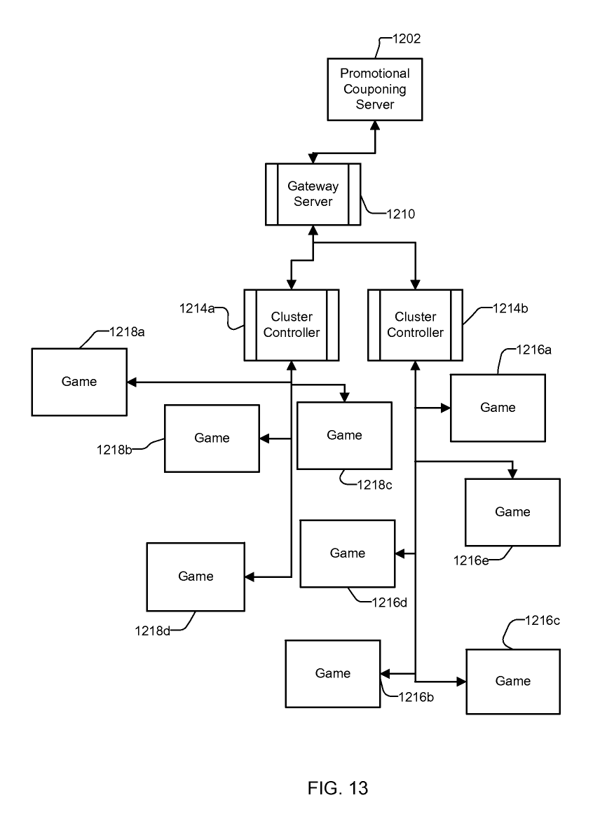

FIG. 13 is a diagram illustrating the components of the PCS directing players to one or a plurality of games in accordance with an exemplary embodiment of the present invention. A component or plurality of components could be optional.

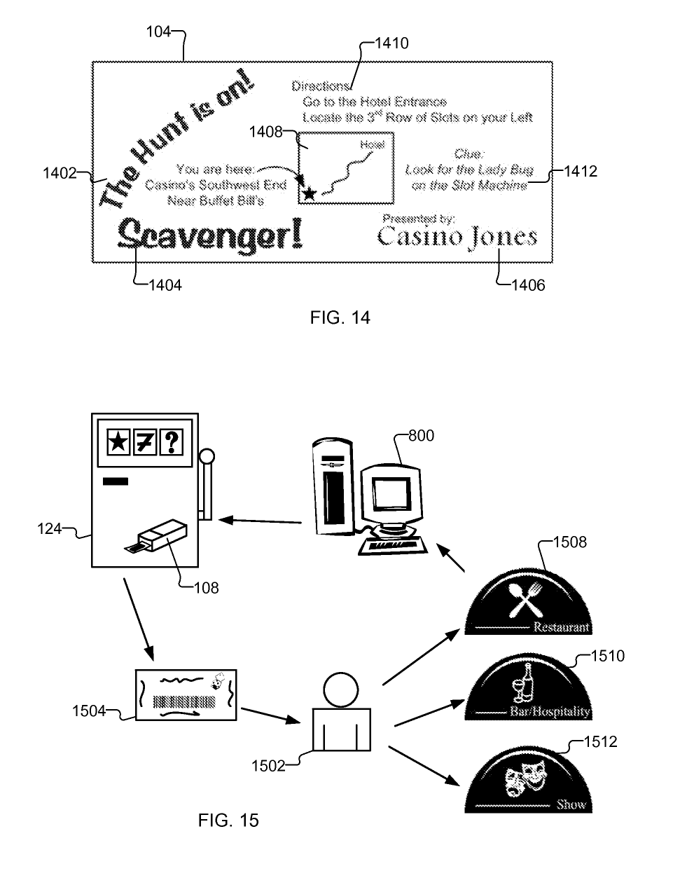

The components of FIG. 13 are previously disclosed in FIG. 12. In this embodiment, a gaming establishment can direct a player to one or more games that are the least played or among the least played games in the gaming establishment. Using a system in accordance with an exemplary embodiment, a gaming establishment can create a promotional coupon to direct or maneuver a player to a certain game in the gaming establishment or elsewhere. The promotional coupon can include a map and/or directions, among others to guide a player. Additional details are disclosed in FIG. 14 as well as throughout this specification.

Additionally, parameters such as start and end date and time and game identification, among others, and triggers such as number of plays, and number of wins and/or losses, among others can be set. The data is saved on a host system and sent to a printer in one or more cashless enabled gaming machines, and if the criteria set is met, the player receives the promotional coupon. The player can then use the promotional coupon to locate the game to play. Additionally, the player can receive prizes for locating and/or playing the game. These prizes can include a free dinner and discount on lodging, among others. An example prize given in the form of a promotional coupon is disclosed in FIG. 3 and FIG. 14.

In another embodiment, data can be partially stored in a host system and a printer.

In the operation of an embodiment, a gaming establishment has identified that game 1216c is the least played game on the gaming floor. The gaming establishment uses the promotional coupon server 1202 to create the promotional coupon to direct players to game 1216c. The promotional coupon is created and saved on a host system. All the data or partial data is transmitted through a gateway server 1210 and one or a plurality of cluster controllers 1214a and 1214b to a printer (not shown) in one or a plurality of games such as games 1218a, 1218b, 1218d. When player A plays, for instance, game 1218a and the criteria and/or triggers are met, the player receives a promotional coupon directing them to game 1216c. Further, player B playing game 1218b receives a promotional coupon directing them to game 1218c. After or during game play of game 1218c, player B receives another promotional coupon directing them to game 1216a. After or during game play of game 1216a, player B receives another promotional coupon directing them to game 1216e.

Further, player A and/or player B can receive additional promotional coupons for prizes such as disclosed in FIG. 3 and FIG. 14.

FIG. 14 is an illustration of a promotional coupon for player guidance in accordance with an exemplary embodiment of the present invention.

In this embodiment, the promotional coupon 104 includes a promotional header 1402 of “The Hunt is on!”, a game name 1404 of “Scavenger!”, and the casino name 1406. Additionally, the promotional coupon includes a map 1408, directions 1410 and a clue 1412 to locate the game.

When a player receives this type of promotional coupon, they can use the map 1408, directions 1410, and/or clue 1412 to locate the game.

Additionally, the promotional coupon can include a barcode (not shown), among others as disclosed in FIG. 3 as well as throughout this specification.

FIG. 15 is an illustration of a functional mode of direct anonymous incentive of the PCS in accordance with an exemplary embodiment of the present invention.

The PCS 800 is an enabling technology, used to define coupons, promotions, campaigns and various rules engines for use. It is the players and patrons 1502 who actually drive the PCS and create the databases by their gaming and shopping activity among others once this environment is established by the PCS administrator. For example, in a direct anonymous incentive process, an un-carded player is provided immediate use coupon 1504 as a result of their wagering activity. The PCS 800 uses the rules engine to process the data related to the anonymous player 1502. The slot play activity on the game 124 in which the printer 108 is installed is analyzed on a real time basis by the printer, and when a trigger is matched, a coupon such as coupon 1504 is issued to the player 1502. Depending on the issued coupon 1504, the coupon can be redeemed at, for example, a restaurant 1508, bar or other hospitality 1510, or a show 1512, among others. The nature of the content of the coupon is to offer the player and award for some good or service offered by the property. The data structures of the printer 108 logic and the server logic is constructed to support this capability, and the PCS 800 contains the ways and means to accomplish this task.

In another embodiment, play activity from a gaming table (not shown) is analyzed in real time by the printer. When a trigger is matched, coupon 1504 is issued to the player 1502.

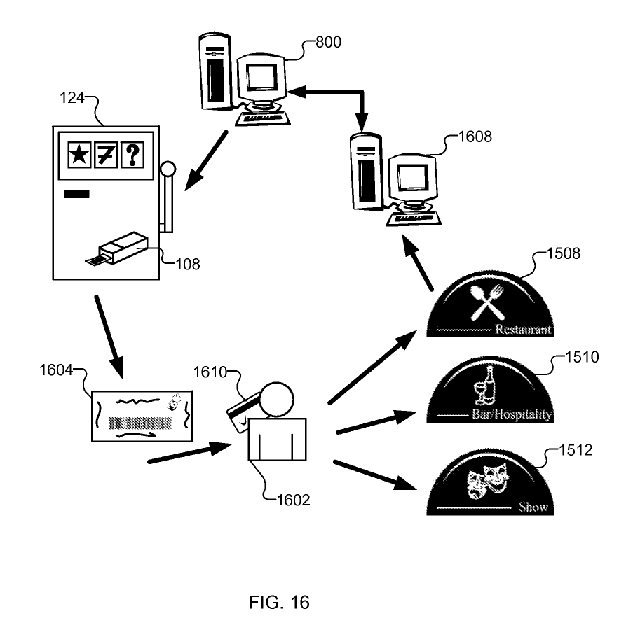

FIG. 16 is an illustration of a functional mode of direct carded player of the PCS in accordance with an exemplary embodiment of the present invention.

In this illustration, a carded player 1602 is provided an immediate use coupon 1604 as a result of wagering activity, enhanced by player class, wagering history and other factors. The slot play activity on the game 124 in which the printer 108 is installed is analyzed on a real time basis by the printer, and in addition to the slot play activity, information related to the player's status or activity within the club are also additive to the analysis. When a trigger is matched, a coupon 1604 is issued to the player 1602. Depending on the issued coupon 1604, the coupon can be redeemed at, for example, a restaurant 1508, bar or other hospitality 1510, or a show 1512, among others. The nature of the content of the coupon 1604 is to offer the player 1602 and award for some good or service offered by the property. The data structures of the printer 108 logic and the server logic is constructed to support this capability, and the PCS 800 contains the ways and means to accomplish this task. Additionally, it requires that the PCS be connected to the PTS 1608 at the property, communicates the required protocol with the PTS, and can correlate information contained in the PTS database with triggers programmed in the PCS. The goods and/or services can include a restaurant 1508, bar hospitality 1510, and/or show 1512, among others.

In a variation, the award can be issued to the card of the carded player 1602, such as a PTS card (1610).

In another embodiment, play activity from a gaming table (not shown) is analyzed in real time by the printer 108, and in addition to the game play activity, information related to the player's status or activity within the club are also additive to the analysis. When a trigger is matched, a coupon 1604 is issued to the player 1602.

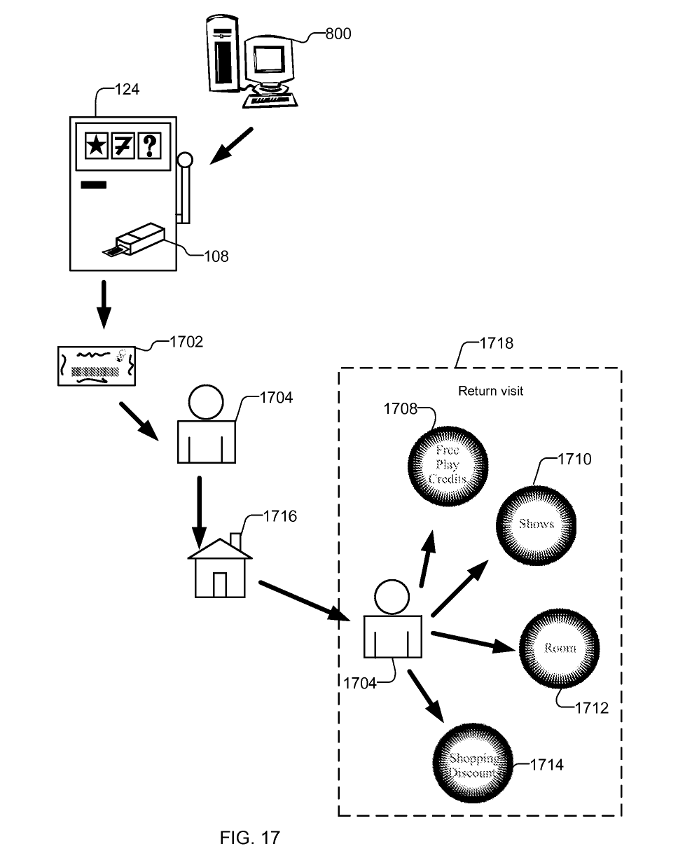

FIG. 17 is an illustration of a functional mode of future incentive of the PCS in accordance with an exemplary embodiment of the present invention.

In this illustration, the player coupon 1702 acts like a mailer to provide an incentive for a return visit. The PCS 800 contains programming capability and a time clock (not shown) which allows it to set the window of time, referenced to moment that the coupon 1702 is issued, that the coupon is valid and that said valid period would be in the future so as to incentivize a player 1704 to return at a later date to the property. The coupon 1702, issued by the printer 108 in the game 124, can be for free play credits 1708, shows 1710, room 1712, and/or shopping discounts 1714, among others.

For example, during a visit, a player 1704 plays a game 124. At any time during game play, a printer 108 installed in the game issues a future incentive coupon 1702 to the player 1704 based on signaling from the PCS 800, which the player takes home 1716 with them. Upon returning 1718 to the gaming establishment, the player can redeem the coupon.

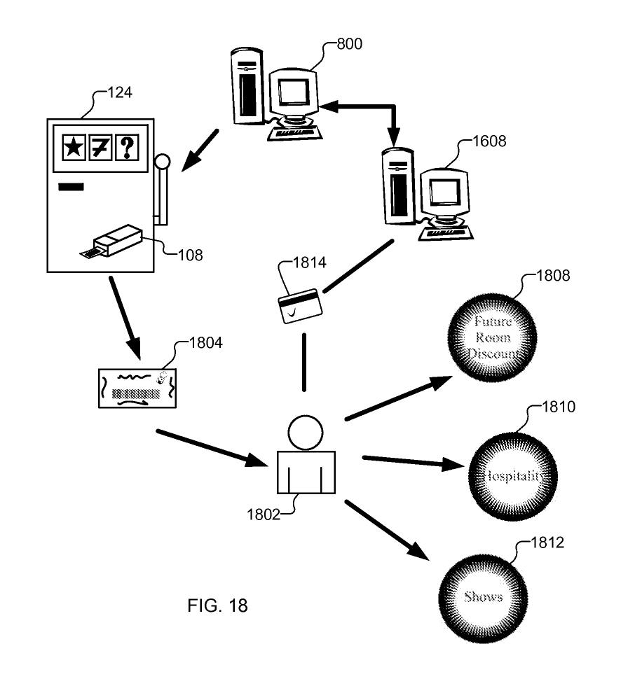

FIG. 18 is an illustration of a functional mode of lure to player club of the PCS in accordance with an exemplary embodiment of the present invention.

As illustrated, a nonparticipating player 1802 is provided immediate incentive to join player club. The PCS 800 being connected to the PTS 1608, upon determining that a trigger is met, connects to the PTS to obtain a join the club award, and this award is correlated in the PCS to the coupon 1804. The coupon, issued by the printer 108 in a game 124, can include awards for a future room discount 1808, hospitality 1810, and/or shows 1812, among others.

In a variation, the award can be issued to the card of the carded player 1802, such as a PTS card 1814.

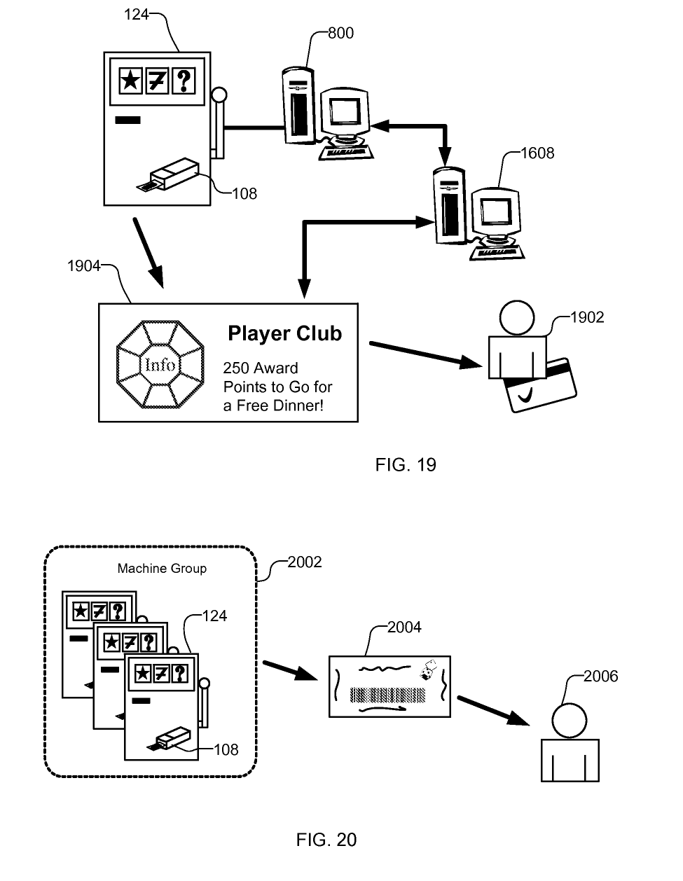

FIG. 19 is an illustration of a functional mode of player club enhancement of the PCS in accordance with an exemplary embodiment of the present invention.

As illustrated, club members 1902 obtain coupons or tickets 1904 communicating important information related to the club. The PCS 800 being connected to the PTS 1608, using PTS data related to the particular player 1902 to cause a trigger and the resultant event is to issue an informational ticket 1904 which communicates certain club information to the player such as award thresholds and/or new programs, among others. The coupon or ticket is issued by a printer 108 in a game 124.

FIG. 20 is an illustration of a functional mode of auxiliary bonusing of the PCS in accordance with an exemplary embodiment of the present invention.

As illustrated, targeted location specific bonusing can be accomplished. The PCS running a promotion on the printers 108 installed in a game 124 in a machine group 2002 (such as a particular grouping of slot machines), and upon a trigger being met, a monetary or raffle entry award coupon 2004 being printed by a printer 108 in a game 124 for the player 2006.

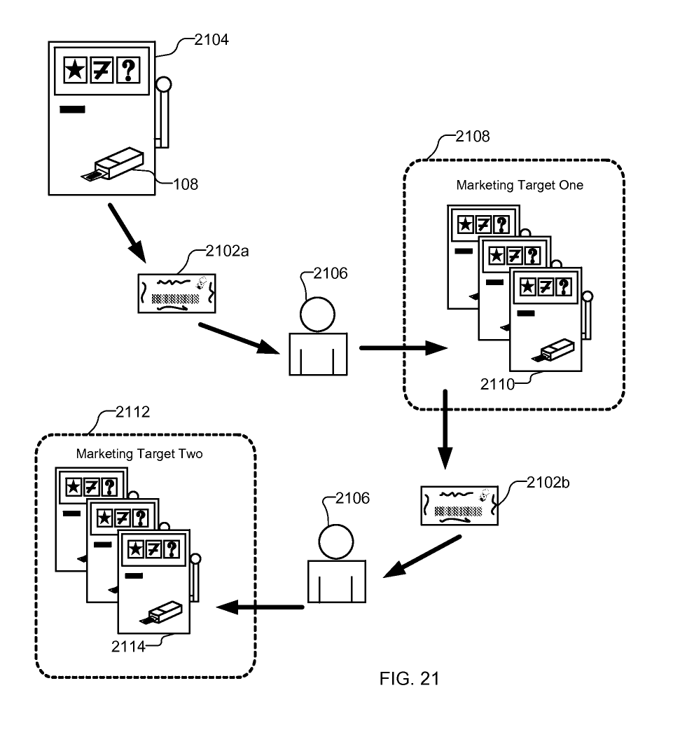

FIG. 21 is an illustration of a functional mode of progressive couponing of the PCS in accordance with an exemplary embodiment of the present invention.

As illustrated, the value of the coupon increases as play continues and moves around the gaming establishment floor. The PCS using the redemption of a coupon (via its validation sequence) as the trigger to the cause the issuance a new coupon. In this manner, a temporary chain of redemption and new issue is created.

For example, a printer 108 in the game 2104 prints a coupon 2102a which the player 2106 redeems at a game in marketing target group one 2108, for example game 2110. After playing game 2110, the printer 108 in the game prints another coupon 2102b (using, for example a sequential number or other means of tracking). The player 2106 redeems this coupon at a game 2114 in marketing target group two 2112.

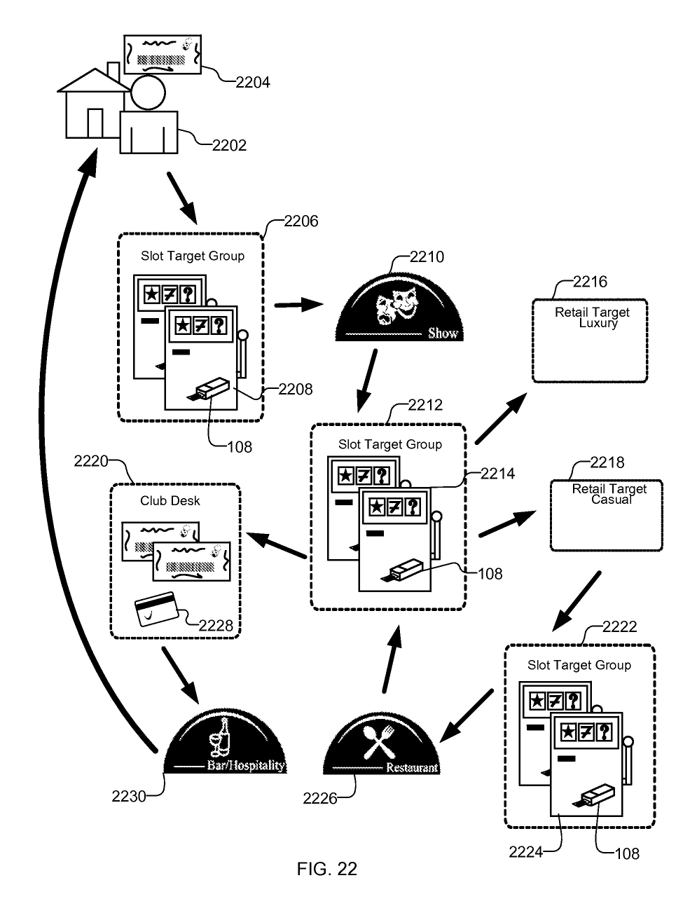

FIG. 22 is an illustration of a functional mode of patron steering and circulation of the PCS in accordance with an exemplary embodiment of the present invention.

As illustrated, the campaign controls support all modes of player and/or gaming establishment interaction. Multiple target locations, running different campaigns and/or promotions, can steer patrons around the property venues. To accomplish this, the PCS (not shown) contains the databases, ways and means to program and distribute different campaigns and/or promotions to different locations thereby allowing one or more coupons to be printed.

For example, a patron 2202 receives a coupon 2204 during a previous visit. Upon returning to the gaming establishment and/or associated gaming establishment, the patron redeems the coupon at a game 2208 in slot target group 2206. At any time during game play, the patron receives another coupon (not shown) good for a show 2210, the coupon printed by a printer 108 connected to the game 2208.

The patron then redeems the show coupon (not shown) at the show 2210, after which the patron receives another coupon (not shown) for game play at a game 2214 in slot target group 2212. After redeeming the game play coupon (not shown), the PCS can cause the game 2214 to issue any one, all, or a combination of the following coupons: a coupon for retail luxury shopping 2216, a coupon for retail casual shopping 2218, a coupon for players club 2220, among others.

Continuing, the printer 108 in game 2214 in slot target group 2212 issues a coupon (not shown) for casual shopping 2218. After the patron redeems the casual shopping coupon, the PCS connected to the POS (not shown) of the retail target issues a coupon (not shown) for game play at slot target group 2222. After redeeming the game play coupon, the printer 108 in the game 2224 issues a coupon (not shown) for a restaurant 2226. After the patron redeems the restaurant coupon, the patron receives a coupon for game play at slot target group 2212.

After the patron redeems the game play coupon, the printer 108 in the game 2214 issues an award coupon for the player club 2220. After the patron redeems the coupon at the club desk and possibly receiving a club card 2228, the PCS issues a coupon for bar hospitality 2230 to the patron. After the patron redeems the bar hospitality coupon, the patron receives a coupon 2204 for future incentive.

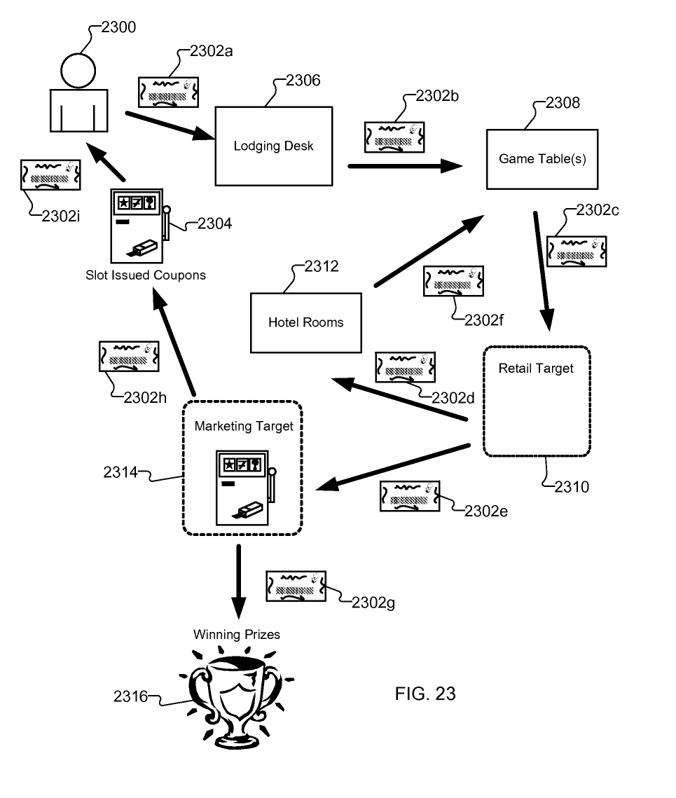

FIG. 23 is an illustration of a functional mode of scavenger hunt of the PCS in accordance with an exemplary embodiment of the present invention.

As illustrated, coupons move players in pursuit of scavenger hunt prize. The PCS (not shown) is programmed to organize a scavenger hunt. For the purposes of this document, a scavenger hunt is akin to a guided treasure hunt whereby a patron 2300 must collect one or more coupons such as 2302a through 2302i from one or more locations such as at a game such as a slot machine 2304, a lodging desk 2306, a game such as a gaming table 2308, retail target 2310, hotel room 2312, and marketing target 2314, among others, by meeting various triggers. The coupons may or may not contain various clues as to how additional coupons can be collected. The end result of the scavenger hunt is to guide the patron to an end location 2316 where the collection of coupons are presented in order to obtain a price, free game play, enter a drawing, free shows, or other awards and incentives.

In order to accomplish this, the PCS:
(a) connects to a number of other systems, such as the LMS, Slot System, TITO System, Game Table System, and POS, among others,
(b) establishes and maintains separate databases for each unique scavenger hunt,
(c) correlates the validation sequences of the various coupons to the particular scavenger hunt, and
(d) determines with the scavenger hunt is complete, as pre-determined by the PCS administrator.

Additional details are disclosed throughout this specification.

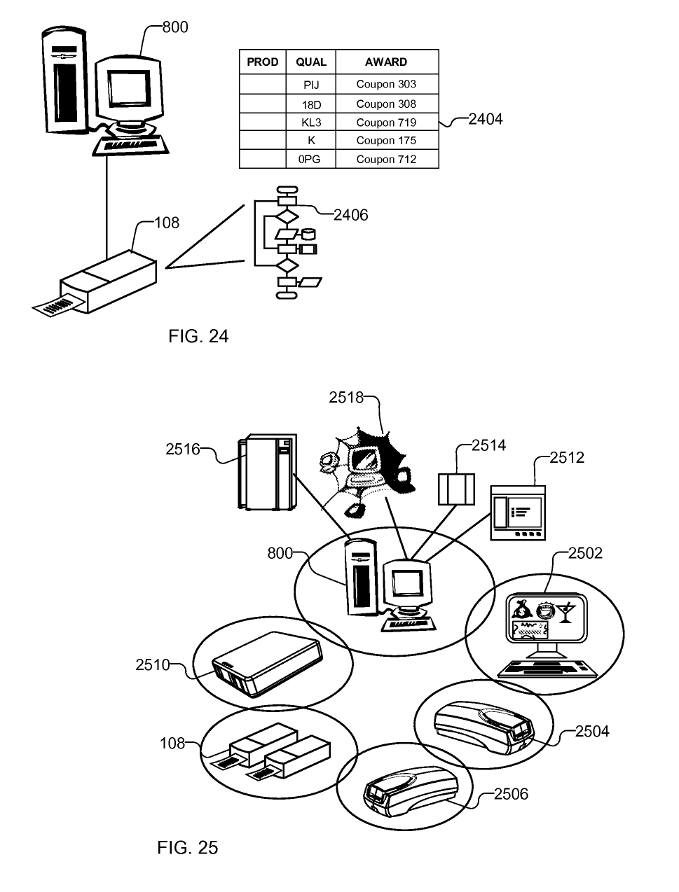

FIG. 24 is an illustration of a functional mode of load sharing of the PCS in accordance with an exemplary embodiment of the present invention.

Load sharing is used to describe the functionality where PCS components share the burdens of real time data processing, analyzing and management. The PCS 800 is really a massively parallel system with each printer 108 being a co-processor to the server. The table below lists some of the various data functions of the PCS and how those functions can be shared across this massively parallel system.

TABLE VII

| Server 800 | Printers 108 |
|---|---|
| Stores promotional database(s) 2404 | |
| Controls content and campaigns | |
| Promotion and campaign design | Real-time data sifting for triggers |
| Real-time data analysis algorithms to look for a | Real-time data analysis algorithms 2406 to |
| trigger | look for a trigger. The data analyzed may be |
| | collected locally by the printer or received |
| | from the server |
| Routing data from other systems (PTS, POS, | |
| LMS, etc.) associated with activity related to | |
| the location where the printer 108 is installed | |
| Issuing approval and a validation sequence for | |
| coupons when a trigger is met. | |
| Storing coupon graphical designs and data | Storing coupon graphical designs and data |
| structures | structures |

FIG. 25 is an illustration of the components of the PCS in accordance with an exemplary embodiment of the present invention.

As illustrated, some of the key components in the PCS, such as servers, software clients, printers and print and redeem devices provide for a complete couponing environment. These include a PCS Server 800, one or more administration interfaces 2502, one or more print and redeem devices 2504 and 2506, one or more printers 108, and one or more routing devices 2510.

The PCS 800 includes the application 2512 and couponing and redemption logic 2514 that includes a rules engine module that determines whether triggers programmed in an administration interface have been satisfied and a coupon is to be issued. The intelligence of this is distributed between the server to the promotional terminals or modules 2516 to support a broad range of rules engines and reliable scalability. The PCS includes a validation module (not shown) that provides unique validation sequences. The PCS includes a redemption module (not shown) which approves any coupon redemption. The PCS includes databases and modules (not shown) which provide audit trail, accounting records, event logs and the methods to export these for viewing and to other systems, among others.

Additionally, the PCS 800 includes a web interface 2518. The web interface is a module in the PCS server whose responsibility is to connect the PCS to create a WAN via the Internet. Security is provided for example, via MS IIS. Promotional terminal http web server embedded firmware allows one or more remote terminals to connect securely to the PCS via the Internet to subscribe to the WAN.

Additionally, the PCS 800 includes one or more server modules 2516. The server modules are responsible for promotional terminal management of components (such as a printer and print and redeem device), real time promotional firmware revision control, and campaign refreshing of the promotional terminal fleet.

The server modules 2516 of the PCS 800 provide for secure communications between a connected host application and components of the promotional terminals such as a printer 108 and a print and redeem device 2504. The secure communications protocol includes for example, GSA protocols.

The server modules 2516 are responsible for load balancing and task sharing to insure that the PCS 800 is fully scalable from gaming establishments of a hundred slots to large installations of 5,000 machines or more. This module dynamically looks at floor usage demand and divides up printer blocks and/or print and redeem blocks to level out demand on each individual server. Further detail is disclosed in FIG. 24.

A routing device 2510 is a secure module such as an Ethernet GSA connection module which securely connects a printer, such as a slot or floor kiosk embedded printer to the PCS 800. The routing device also provides a fully separate promotional processing environment from the TITO functions in the printer, thereby allowing the PCS functionality to be associated equipment, even when blended with TITO printing. The routing device also provides arbitration support to insure fully TITO/promotional compatibility under all conditions.

In one embodiment, the routing device 2510 is embedded in a promotional terminal such as a slot or floor kiosk embedded printer. In another embodiment, the routing device connects to slot or floor kiosk embedded printer. In another embodiment, the routing device is a separate device. In another embodiment, the routing device is incorporated into a printer 108.

Each printer 108 prints coupons based on signaling from the PCS 800. One printer used with the PCS includes an embedded routing device 2510 and is classed as a promotional terminal. Another printer connects to a routing device for connection to the PCS. This combination of printer and routing device is classed as a promotional terminal. Another printer is a tabletop packaged coupon issuance printer.

Another promotional terminal includes a print and redeem device 2504. One print and redeem device is a coupon redemption and issuance terminal including a 2D barcode scanner and a magnetic card reader, among others. This type print and redeem device is intended for use at POS, and other concession locations. It is a remote location coupon print and redeem unit containing all the print, paper and interface functions necessary to generate coupons, redeem coupons, and receive signaling from one or more systems, among others. This type print and redeem device also includes an administrator interface for processing player and patron targeted awarding as well as redemption information feedback. This type print and redeem device is Internet connectable whereby coupons can be issued at extranet locations. In one embodiment, this type printer is a tabletop packaged print solution.

Another print and redeem device 2506 is a table TITO device that also serves as a coupon terminal at the tables. This terminal also contains a 2D barcode scanner and a magnetic card reader. This type print and redeem device is intended for use at gaming tables (black jack, roulette, etc.) as a table-based TITO and coupon unit to provide TITO and coupons at the table for TITO issuance and redemption and/or coupon issuance and redemption. This type print and redeem device provides means for an administrator's interface and player targeted awards, among others. Additionally, this type print and redeem device provides means for a SMIB system connection card for connection to a slot machine or game.

One or more administration interfaces 2502 provides a client application. One administration interface includes a graphical coupons design studio environment that supports the creation of coupon designs, and exports the designs in a printer ready format for use by the system, among others.

Another administration interface 2502 includes a module that allows the creation of event triggers that cause a coupon to issue, a module that allows the linking of coupons to triggers resulting in the creation of promotions, a module that allows the bundling of promotions into campaigns, campaign stagegate approval release processes, and/or a coupon redemption activity and statistics viewer, among others.

The PCS 800 also includes a target group administration client application (not shown) that allows the grouping of promotional terminals into target groups by IP address. Server modules perform communications routing to target groups.

The PCS 800 also includes one or more enterprise systems interfaces to one or more enterprise service servers. An interface is for example, an S2S interface to connect the system to other enterprise systems which also support an S2S interface. An enterprise service server is responsible for connecting legacy systems to the PCS using an enterprise systems interface. An example legacy system includes systems that use non-GSA protocol. Additional detail is disclosed in FIG. 11.

One or a plurality of devices of the PCS 800 can be installed in various physical locations. The various physical locations include lodging desk, leased locations, owned locations, tables, slot issued coupons at games, player loyalty desk, floor kiosks, and/or hotel rooms, among others. Additionally, locations such as hotel rooms, leased locations, and/or owned locations, among others may be connected using a connection such as the Internet.

The PCS 800 can interface to target groups both within and outside the property location by use for example, of the Internet. This essentially makes the PCS world wide in deployment scope. The target groups can include, among others, remote location, retail group, EGM titles, EGM banks, and/or EGM demons.

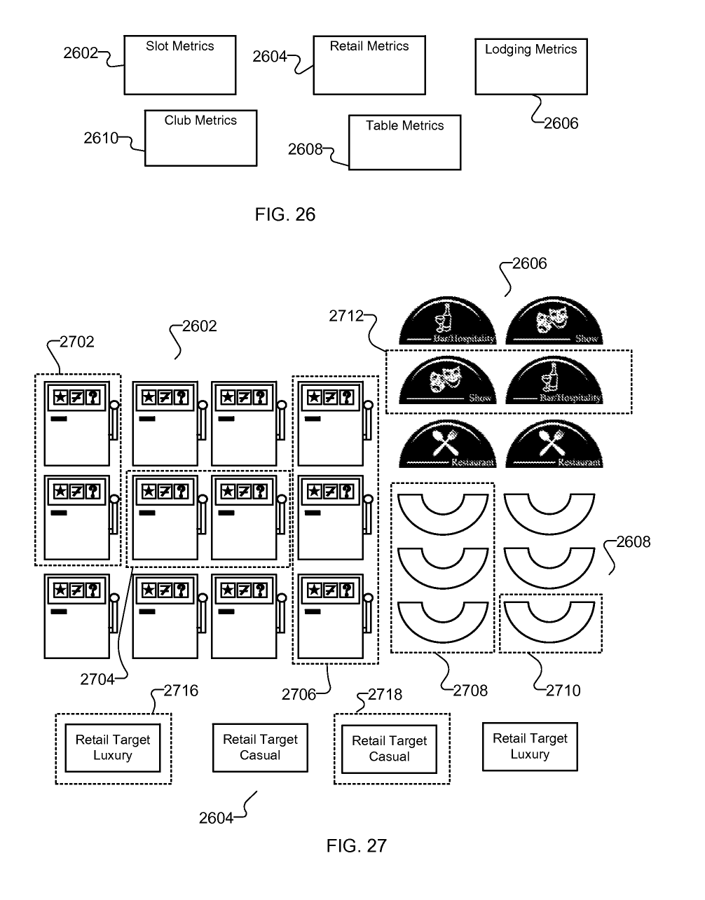

FIG. 26 is an illustration of a grouping of various rules engines into their respective classes in accordance with an exemplary embodiment of the present invention.

As illustrated various rules engines are grouped into their respective classes. The trigger rules engine are printer embedded and classed by metric type. These classes are assigned based on the nature of the data which is processed by the rules engines. For instance, the data related to slot play may be the amount of money wagered, or time of play on the game, and so this is classed as slot metrics 2602. Data related to POS locations may be the amount of money spent, or the particular item purchased, and so rules engines related to this type of data are classed as retail metrics 2604.

Lodging metrics 2606 may include the date a player checked into the hotel. Table metrics 2608 may include the amount played. Club metrics 2610 may include the last time a player played a game.

FIG. 27 is an illustration of how different rules engines may be loaded into printers at various types of locations in accordance with an exemplary embodiment of the present invention.

As illustrated different rules engines may be loaded into printers at the various types of locations. Under this architecture, each connection is capable of running independent rules engine thereby providing complete system flexibility. It is possible that a property could be running several dozen or more rules engines simultaneously. What is not shown here, but is intended and disclosed in this specification, is that in addition to the printers containing rules engines, they would also contain different Promotions at these locations.

For example, illustrated are the following rules engines: 18 classed as slot metrics 2602, 6 classed as table metrics 2608, 6 classed as lodging metrics 2606, and 8 classed as retail metrics 2604. The currently running rules engines are illustrated as slot metrics 2702, 2704, and 2706; table metrics 2708 and 2710; lodging metrics 2712; and retail metrics 2716 and 2718.

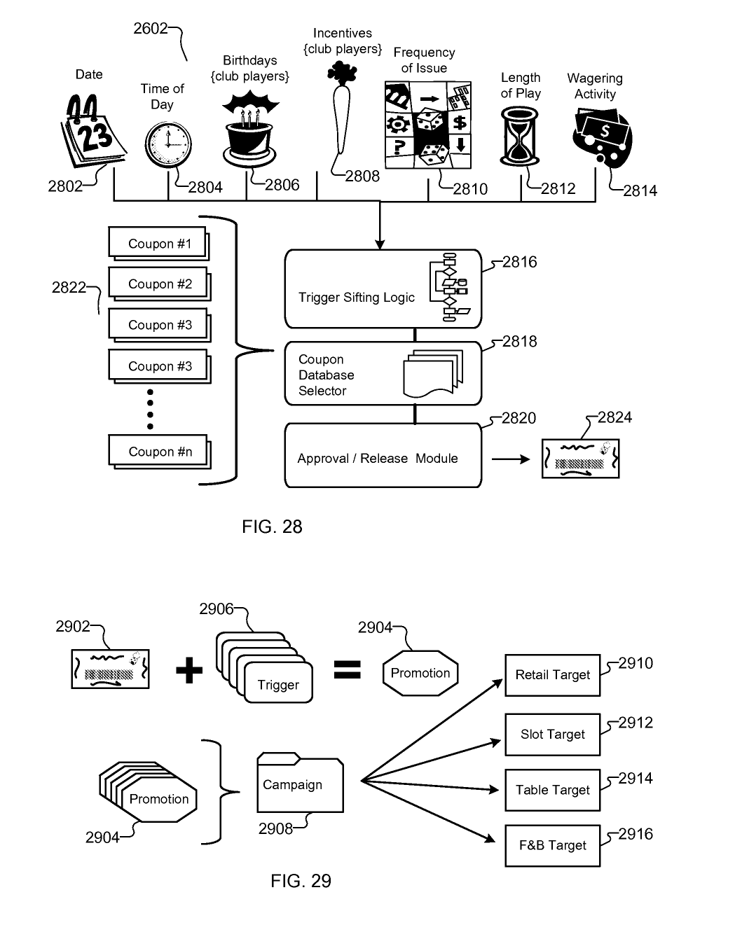

FIG. 28 is an illustration of a rule engine for slot metrics in accordance with an exemplary embodiment of the present invention.

The illustrated slot metrics 2602 are, among others, date 2802, time of day 2804, birthdays 2806, incentives 2808, frequency of issue 2810, length of play 2812, and wagering activity 2814. Any, all, or a combination of these are used with the trigger sifting logic 2816 and/or coupon database selector 2818 to select one or more coupons 2822 for issue 2824 using an approval/release module 2820. Additionally, the trigger sifting logic is embedded in all connection devices such as a printer or print and redeem device.

FIG. 29 is an illustration of a promotion and campaign database architecture in accordance with an exemplary embodiment of the present invention.

As illustrated, a promotion 2904 is a coupon 2902 and a set of triggers 2906 for that coupon. A campaign 2908 is a collection of promotions. Campaigns are then loaded to one or various target groups such as, among others, retail target 2910, slot target 2912, table target 2914, and/or food and beverage target 2916.

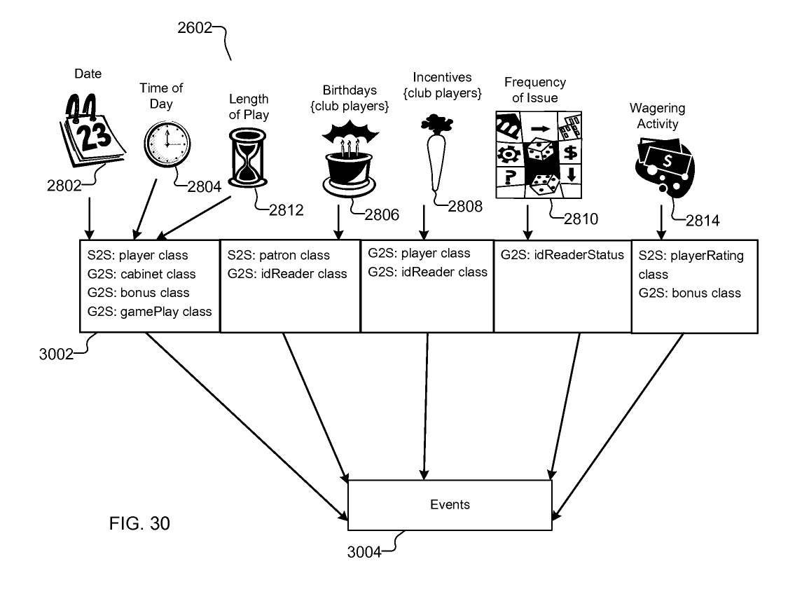

FIG. 30 is an illustration of how G2S can be used as a protocol to obtain the various metrics which would be sifted to look for triggers in accordance with an exemplary embodiment of the present invention.

As illustrated, triggers are mapped to classes such as G2S classes and S2S classes 3002. Any, all, or a combination of triggers such as, among others, date 2802, time of day 2804, birthdays 2806, incentives 2808, frequency of issue 2810, length of play 2812, and wagering activity 2814 can be used with, for example, S2S: player class to trigger an event 3004.

For example, a player inserts her player card. The card reader sends the player's birthday to the electronic gaming machine (EGM), which in turn sends a G2S idReader message to the PTS. The PTS sends a S2S patron message to the PCS. The printer connected to the PCS gets a notification and triggers a coupon to print.

In another example, a player inserts a card or cash to start a session. The EGM starts a session and notifies the PTS (for example, using G2S_PRE100 class). The PCS receives a notification. The player finishes playing and removes her card or requests a cash out (for example, using G2S_CBE316). The EGM ends the session and notifies the PTS (for example, using G2S_PRE103). The printer and/or PCS gets the notification and prints a coupon.

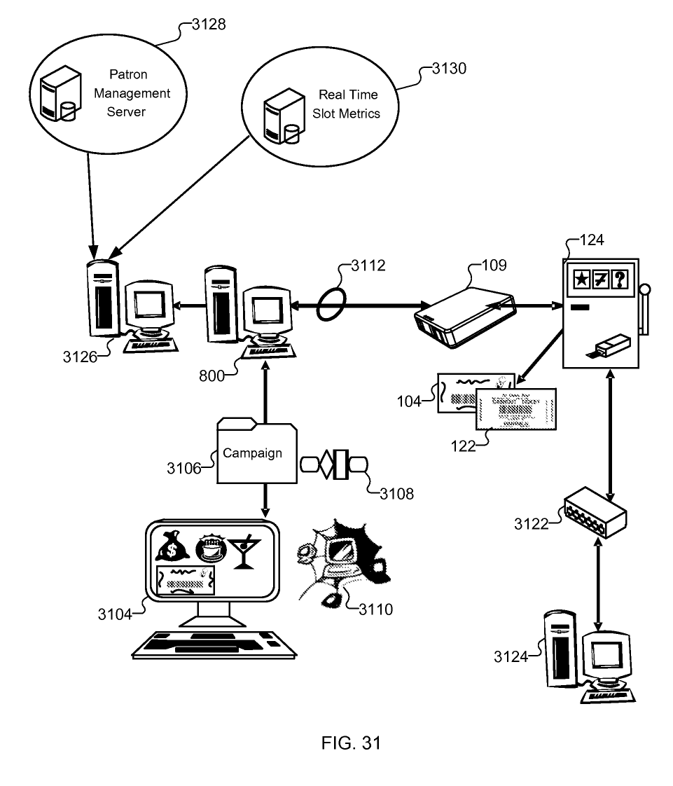

FIG. 31 is an illustration of a typical connection of the PCS within a gaming establishment in accordance with an exemplary embodiment of the present invention.

In this illustration, a PCS administrator uses an administrator interface 3104 to design campaigns 3106 and/or rules engine 3108, among others. The administrator using a connection such as the Internet 3110 transmits the campaigns and/or rules engine to the PCS 800. The PCS using a secured connection 3112 such as secure Ethernet, transmits coupons to a routing device 109 which in turn, transmits the coupons to a game 124. The game is capable of issuing coupons 104 and vouchers 122. The game also connects using a slot machine interface board (SMIB) 3122 to a TITO System 3124. Data regarding the coupons, triggers, and/or rules engines are transmitted from the game back to the routing device which in turn, transmits the data to the PCS. Additionally, the PCS is connected to other host systems 3126 for data exchange and transmission, such as for a patron management server 3128 and real time slot metrics 3130.

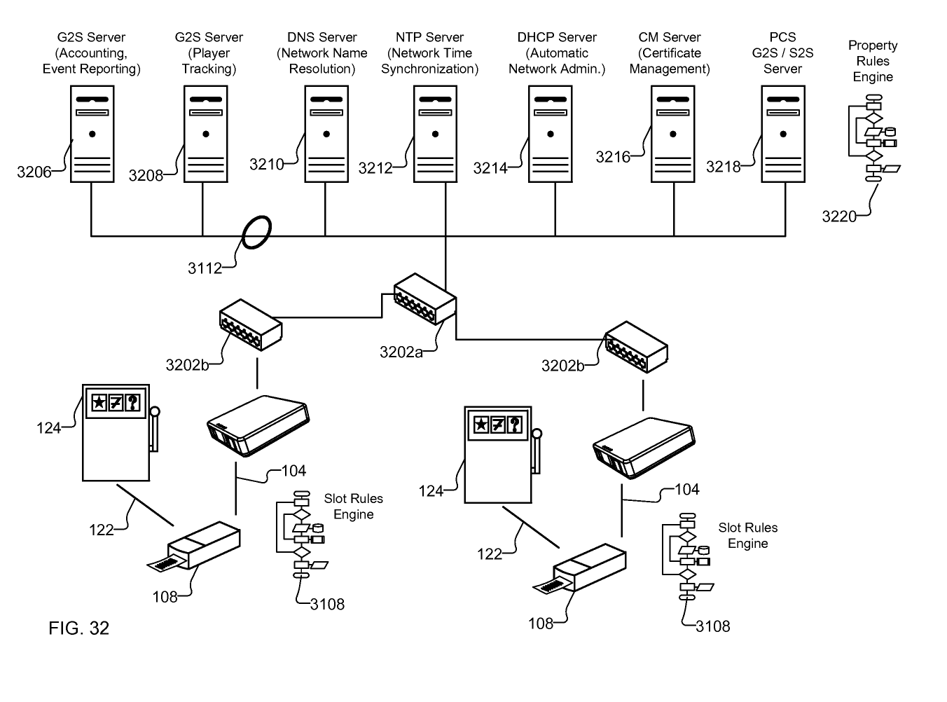

FIG. 32 is an illustration of a connection of the PCS and its printers within a GSA defined casino network topology in accordance with an exemplary embodiment of the present invention.

As illustrated, a plurality of systems using secured Ethernet communications 3112 interface 3202a and 3202b with a printer 108 connected to a game 124 for the issuance and/or redemption of vouchers 122 and/or coupons 104. For GSA, the printer listens via G2S to get the slot play metrics 3108.

The systems include:
(a) G2S server for example, for accounting and event reporting 3206 and player tracking 3208
(b) DNS Server for network name resolution 3210
(c) NTP Server for network time synchronization 3212
(d) DHCP server for automatic network administration 3214
(e) CM server for certificate management 3216
(f) PCS G2S/S2S server for promotional couponing 3218. The PCS uses the property rules engine to authenticate coupons, download campaigns, and provide a property interface 3220.

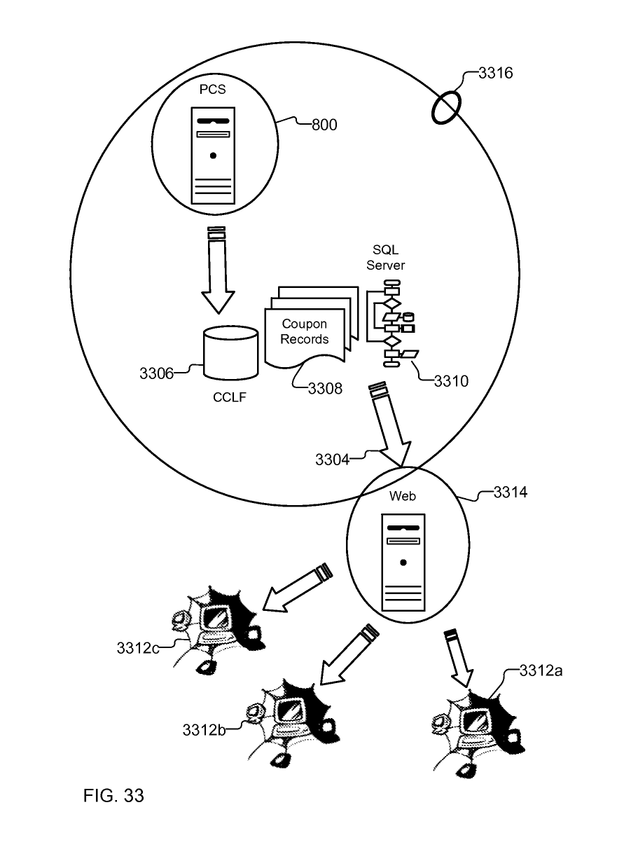

FIG. 33 is an illustration of the PCS connecting to various administrator clients via the Internet in accordance with an exemplary embodiment of the present invention. This allows multiple administrators to manage the system for remote and within property locations.

In this embodiment, the PCS 800 connects via a web service 3304 to provide coupon issuance to remote locations using, for example, the Internet. The PCS and coupon database 3306 identify the coupon records 3308 which may be queried by an SQL server 3310. Using IIS 3316, a casino IT department can control security and access to the PCS. An Internet user 3312a, 3312b, and 3312c interfacing with a Web server 3314 can access the PCS.

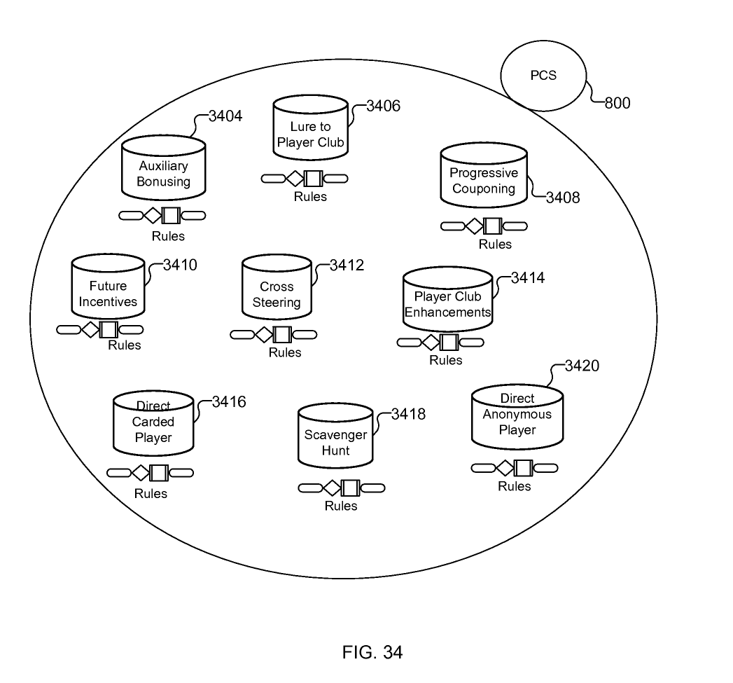

FIG. 34 is another illustration of the PCS as an enabling technology in accordance with an exemplary embodiment of the present invention.

As illustrated the PCS 800 is an enabling technology, used to define campaigns and various rules engines for use. It is the patrons who actually drive the PCS by their gaming and shopping activity among others once this environment is established by the PCS administrator. The wide variety of rules engines possible makes for completely different environments and allows casino property operators to differentiate from their competitors, even though they also might be running the PCS. By allowing the players and patrons and their activity to drive the system, the patrons experience is more enjoyable, the behavior of the patrons is directly affected by the marketing programs, and the patron interaction with the systems make the entire system event driven where the event is the individual patron's activities.

Each patron's activities build a PCS 800 database based on a rule or set of rules created by an establishment. For example, the PCS server can include the following databases:
(a) Auxiliary bonusing 3404 stores data and a rule or set of rules related to auxiliary bonusing, for example, promotional couponing in addition to other couponing such as scavenger hunt 3418.
(b) Lure to player club 3406 stores data and a rule or set of rules related to providing one or more incentives for a player to join the PTS.
(c) Progressive couponing 3408 stores data and a rule or set of rules related to progressive couponing where the value of a coupon increases as play continues.
(d) Future incentives 3410 stores data and a rule or set of rules related to incentives for a return visit by a player or patron.
(e) Cross steering 3412 stores data and a rule or set of rules related to steering players and/or patrons.
(f) Player club enhancement 3414 stores data and a rule or set of rules related to the PTS which relay important club information, among others, to a player or patron.
(g) Direct carded player 3416 stores data and a rule or set of rules related to direct carded player when the players are a member of the PTS.
(h) Scavenger hunt 3418 stores data and a rule or set of rules related to scavenger hunt including the hunt prize.
(i) Direct anonymous player 3420 stores data and a rule or set of rules related to direct anonymous players when a player is not a member of the PTS.

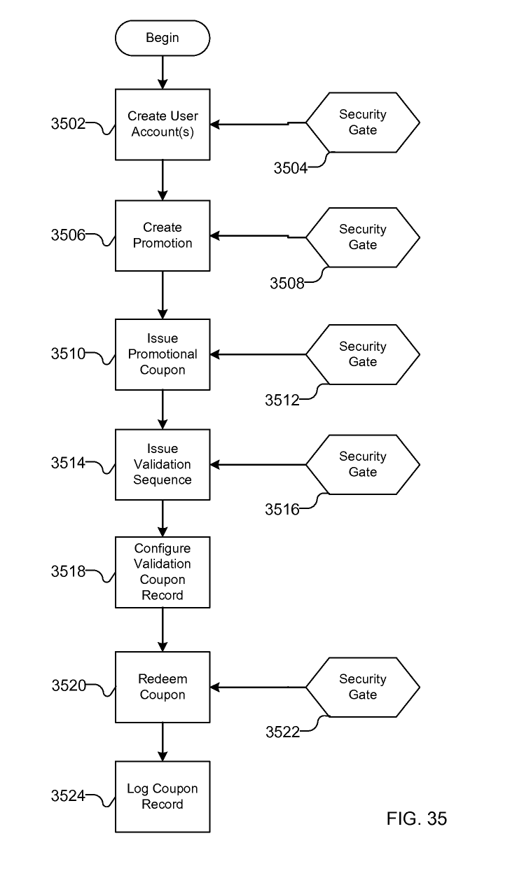

FIG. 35 is a flow chart of security measures in the PCS in accordance with an exemplary embodiment of the present invention.

The first step is the create user accounts 3502 where the system administrator creates user accounts for authorized promotional administrators. A security gate 3504 can include Administrator P/W or password is required for system administrator to access server to establish user accounts.

In create promotion 3506, an authorized user accesses the promotional server to create a promotion. A security gate 3508 can include a User P/W or password is required to access server for authorization.

In issue promotional coupon 3510, the promotional server, working in conjunction with the TITO printer, determines that a promotional trigger (designed by a user) is met. A security gate 3512 can include that the server must authorize promotional coupon issuance on a particular printer in a particular game.

In issue validation sequence for the coupon 3514, the promotional server creates a semi-random validation sequence for the coupon and issues the sequence to the printer as part of the coupon issuance authorization. The random portion of the sequence is 12 numeric characters and is only used only for the one coupon, making it in all practical terms impossible to predict (10e12 combinations). The printer prints the validation sequence on the coupon, and upon confirmation of a successful coupon issuance from the printer, the server uses the sequence to create a record within a valid promotions data base located in the server. A security gate 3516 can include where the server creates a random portion of the coupon sequence number with 10e12 permutations. Complete sequence is used only once for a coupon creating a unique signature for the promotion.

In configure validation coupon record 3518, data concerning the promotion is loaded into the valid promotions database indexed against the coupons validation sequence. The data provides a complete signature for the coupon and includes, for example, a validation record containing the promotion, promotional redemption code, and issue date, among others.

In redeem coupon 3520, the coupon is redeemed at a participating location, either by an attended transaction (clerk present) or unattended in the case of a self-serve kiosk. At the time of redemption, the sequence number is communicated to the server and the following checks are completed:

a) The redemption is within the valid date and time

b) The coupon is being redeemed at the proper location

c) The promotion being granted matches the coupon award grant

d) The value of the award granted matches the coupon denomination

A security gate 3522 can include the award redemption which is being attempted matches the profile of the award recorded in the system in the validation sequence's record, including the zone or promotion code type.

In log coupon record 3524, after confirmation that the coupon is valid and the redemption is complete, the server issues an approval which includes another semi-random sequence number of a different format than the coupon's validation sequence to the redemption location for use in canceling the coupon. The server, upon confirmation of the cancellation sequence successful reception, retires the coupon as redeemed and logs it into a redeemed and canceled database also residing in the server. This record can be communicated upon request to the accounting system for the property.

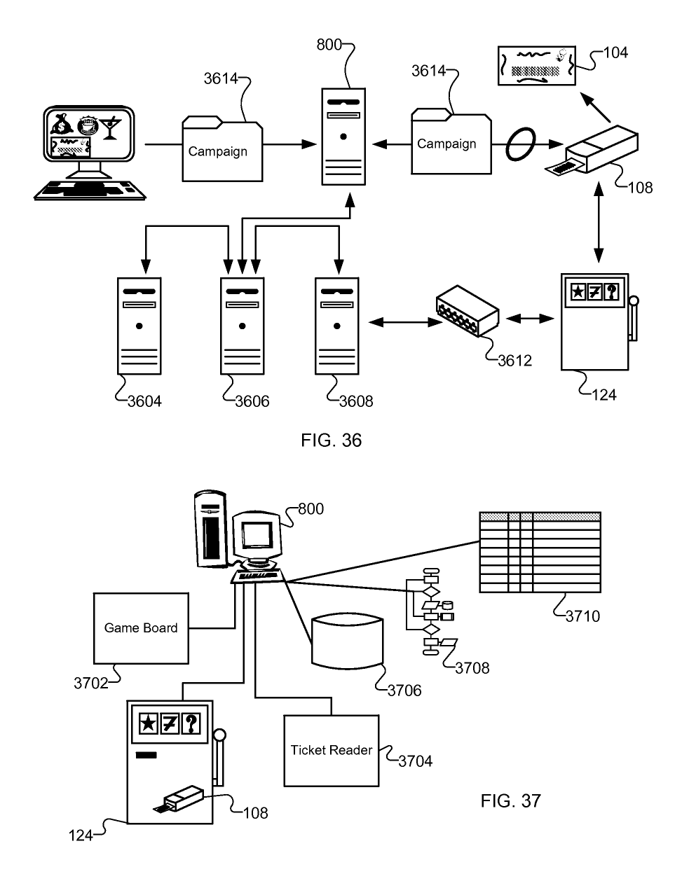

FIG. 36 is an illustration of a connection of the PCS and one of its printers to a casino multi system environment in accordance with an exemplary embodiment of the present invention.

In this illustration, the printer 108 obtains its slot play data metrics from the PCS 800 which in turn receives this information from other systems such as Player Loyalty System 3604, Casino System 3606, and TITO System 3608 at the property which are connected to the slot machines 124 by way of a SMIB 3612. In addition to obtaining the slot play metrics, the printer connects to the PCS to obtain campaign databases 3614, slot metrics rules engines (not shown), and to receive approval to issue a coupon 104 once a trigger is met.

In another embodiment, the printer 108 obtains its slot play data metrics directly from the slot machine 124 and connects to the PCS 800 to obtain campaign databases 3614, slot metrics rules engines (not shown), and to receive approval to issue a coupon once a trigger is met.

In another embodiment, the PCS administrator uses the administrator interface 3104 to create a campaign 3614 which is stored on the PCS 800.

FIG. 37 is an illustration of the PCS in relation to scavenger hunt in accordance with an exemplary embodiment of the present invention.

Illustrated are a host system such as PCS 800, a game 124, a game board 3702, and a ticket reader 3704. The host including one or more databases 3706 where a database is for the scavenger hunt module, algorithms 3708, and a scavenger hunt session table 3710, among others. The game includes a printer 108, among others. The ticket reader includes a print and redeem device (not shown), among others. The ticket reader may be included with a game or kiosk, among others.

The scavenger hunt algorithm 3708 (herein “PCS SHa”) allows scavenger hunt to be conducted with only a sub-set of the scavenger hunt tickets in the possession of the patron, whereby the algorithm will self adapt to personalize the scavenger hunt experience of the patron within a sub-set of complete scavenger hunt designed. The purpose and benefit of this is to allow a complex scavenger hunt to be programmed to cover a number of activities, but still can be run without the patron having to satisfy all aspects of the scavenger hunt, thereby running the risk that they lose interest.

The PCS SHa 3708 being programmed by a graphical interface administrator interface of scavenger hunt module allows the user to perform a visual linking of events, and grouping of events to classes of scavenger hunt sub-set outcomes. An outcome would be perhaps an award or entry into a drawing for a certain award, and the value of the award would escalate based on how completely the scavenger hunt was performed by the patron.

The PCS scavenger hunt module contains a database 3706 which would open up a temporary scavenger hunt session tracking so that each patron's scavenger hunt session could be unique, with its own unique outcome, the outcome to be within the class of outcomes programmed into the PCS through an administrator interface.

The PCS scavenger hunt module 3706 allows all patron tickets to be virtual, with only one physical registration ticket, the ticket to be linked to the temporary scavenger hunt session database entry for that patron where the virtual tickets are accumulated.

The PCS scavenger hunt module 3706 allows the tickets collected by the patron during the scavenger hunt session to be inserted into a ticket reader 3704, for example, a ticket reader connected to the PCS 800, the PCS connected to a game of chance 124, the game of chance being triggered, modified or enhanced based on the collection of patron tickets entered.

The PCS scavenger hunt module 3706 allows the tickets collected by the patron during the scavenger hunt session to be inserted into a ticket reader 3704, for example, a ticket reader connected to the PCS 800, the PCS connected to a game board 3702 whereby the PCS SHa 3708 having accumulated the tickets inserted, would determine which clues on the game board would light up or reveal, in a game show fashion, providing the patron a chance to answer a question, solve a puzzle, or solve a riddle. The outcome of the game can be validated by an attendant. The attendance in turn would receive authorization from the PCS to present an award of some variety to the patron.

Although the present invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

1. A method of promotional couponing for maneuvering players, comprising:
designing promotional coupons, campaigns, and/or promotions using an administrator interface to a promotional couponing system;
designing promotional coupons, campaigns, and/or promotions using static and/or dynamic data and indicia;
issuing promotional coupons, campaigns, and/or promotions to a network of printing devices and/or print and redeem devices;
redeeming promotional coupons based on data received and/or verified from a print and redeem device and/or other connected systems.
